(19) United States
(12) Patent Application Publication
(10) Pub. No.: US 2024/0174537 A1
(43) Pub. Date: May 30, 2024

(54) CONTAINER FOR TREATING CONTAMINATED WATER

(71) Applicant: Syrinx Environmental Pty Ltd, Perth (AU)

(72) Inventors: Simon Hadley, Perth (AU); Kathy Meney, Perth (AU); Andrew Shipp, Perth (AU)

(73) Assignee: Syrinx Environmental Pty Ltd, Perth, WA (AU)

(21) Appl. No.: 18/562,209

(22) PCT Filed: May 24, 2022
(86) PCT No.: PCT/AU2022/050499

§ 371 Date: Nov. 17, 2023

(30) Foreign Application Priority Data
May 24, 2021 (AU) 2021901542
May 24, 2021 (AU) 2021901543
May 24, 2021 (AU) 2021901546

(51) Int. Cl. C02F 3/32; C02F 1/28; C02F 103/00

(52) U.S. Cl. CPC C02F 3/327; C02F 1/286; C02F 2103/007; C02F 2203/006

(57) ABSTRACT

A container for treating contaminated water using biomass, the container comprising an open top, a fluid inlet and a fluid outlet and a carriage configured to move along a length of the container, wherein the carriage comprises a harvester system configured to harvest at least a portion of the biomass and wherein contaminated water is received by the fluid inlet, and treated water is directed to the fluid outlet.

### FIELD OF THE INVENTION

The present invention relates to a container for treating contaminated water.

More particularly, the present invention relates to a modular container configured to receive contaminated water and uses phytoremediation and/or biosorption to produce non-potable or at least partially decontaminated water.

### BACKGROUND

It is known to use plant biomass in a phytoremediation and/or biosorption process to remove contaminants from polluted water.

Phytoremediation occurs naturally in natural environments, for example wetlands, in which plants such as macrophytes form a layer of biomass exposed to sunlight, which stabilise and/or uptake contaminants in stems and rhizomes.

Macrophytes are aquatic plants growing in or near water. They may be either emergent (i.e. with upright portions above the water surface), submerged or floating.

As contaminants are stabilised or absorbed, the contaminant level increases and biomass may need to be harvested regularly to maintain the efficiency of the process and lower the concentration of contaminants in the biomass to enable reuse.

Below the biomass, layers of filtration media may further contribute to the removal of contaminants from the water.

In natural environments the removal and replacement of filtration media is difficult and high risk, to the extent that underlying layers of a wetland are typically left undisturbed and may contain high levels of contaminants as a result.

Growth of biomass is typically considered detrimental, impacting on water quality, diversity and aesthetics, despite the phytoremediation effect of treating the water.

In such environments, biomass removal is typically carried out manually or may be assisted by apparatus such as watercraft comprising skimmers or amphibious craft comprising a cutting device.

However, the present invention involves a containerised modular system, in which the biomass is intentionally cultivated in water in a container which may further include layers of plant-based filtration media.

Harvesting the biomass and/or removal and replacement of filtration media therefore presents a problem, from a practical and safety perspective.

The practical problem is one of retrieving the biomass periodically from a body of water within a container.

The floating and or submerged biomass is small, light and easily disturbed or moved, which makes collecting and harvesting difficult.

Harvesting of emergent biomass requires cutting of the shoots or removal of the plant including rooted portion.

To harvest the biomass manually is not practical as the enclosed space and contaminated water presents a safety hazard.

The layers of filtration media, beneath the biomass, adds further complexity and difficulty.

The relatively small water surface area of a container compared to natural environment such as a wetland requires harvesting to take place over multiple smaller water bodies rather than a single large water body.

The harvesting of biomass and removal and/or replacement of filtration media from multiple smaller water bodies therefore poses a problem.

The present invention attempts to overcome at least in part the aforementioned disadvantages of previous systems by providing a transportable modular treatment system that is more ecologically attractive than known systems.

The following discussion of the background art is intended to facilitate an understanding of the present invention only. It should be appreciated that the discussion is not an acknowledgement or admission that any of the material referred to was part of the common general knowledge as at the priority date of the application.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF INVENTION

In accordance with a first aspect of the present invention there is provided a container configured to treat contaminated water, the container comprising an open top, a fluid inlet and a fluid outlet, wherein contaminated water is received by the fluid inlet, and treated water is directed to the fluid outlet.

In accordance with a second aspect of the present invention there is provided a container configured to contain a body of water and floating biomass, the container comprising; a pair of side walls, a first end wall, a second end wall, a top having an opening, and a carriage configured to move along a length of the container, wherein the carriage comprises a harvester system configured to harvest at least a portion of the floating biomass.

In accordance with a third aspect of the present invention, there is provided a container for treating contaminated water using biomass, the container comprising an open top, a fluid inlet and a fluid outlet and a carriage configured to move along a length of the container, wherein the carriage comprises a harvester system configured to harvest at least a portion of the biomass and wherein contaminated water is received by the fluid inlet, and treated water is directed to the fluid outlet.

Unless the contrary is apparent, embodiments of the above-described principal aspects, and any of those described below, may comprise or incorporate, either individually or in combination, any of the following features.

In an embodiment, the biomass is macrophytic biomass.

In an embodiment, the carriage is mounted upon rails affixed to the container.

In an embodiment, the carriage is configured to be driven by a motor.

In an embodiment, the container comprises a power supply.

In an embodiment, the container comprises an energy store.

In an embodiment, the power supply is configured to charge the energy store.

In an embodiment, the energy store is configured to power the motor.

Alternatively, the power supply is configured to power the motor.

In an embodiment, the carriage is configured to connect to a charging dock proximal a first end of the container, where the container comprises the power supply and wherein the carriage comprises an energy store and motor configured to drive the carriage.

In an embodiment, the container comprises a pump, configured to direct water from the body of water, either to the fluid outlet, or to re-circulate back to the body of water.

In an embodiment, the container comprises a dosing tank, configured to dose the contaminated water received at the fluid inlet, to supplement the process.

In an embodiment, the dosing tank receives treated or partially treated water and enables control feed of this water within the treatment or re-use process.

In an embodiment, the container further comprises a secondary internal tank, configured to provide capacity and storage for either contaminated or at least partially treated water.

In an embodiment, any or all of the pump, dosing tank and secondary internal tank are remotely operable.

In an embodiment, the container has a fluid inlet bypass and a fluid overflow outlet to divert excess water from the container safely.

In an embodiment, the container has a drain outlet to divert excess rainwater from the open tank during transport.

In an embodiment, the container has at least one fluid inlet to flush pipework at least one fluid outlet and divert of contaminated water generated by the process from the container safely.

In an embodiment, the floating biomass is from the ‘duckweed’ genera, Lemna spp or Landoltia spp.

In an embodiment, the container comprises a camera to monitor the water surface biomass coverage.

In an embodiment, the camera is mounted to the carriage.

In an embodiment, the camera is remotely viewable.

In an embodiment, the container comprises a beacon configured to activate before the harvesting operation to warn operators.

In an embodiment, the container comprises a control unit configured to activate the carriage.

In an embodiment, the container comprises a platform configured to provide a safe location from which maintenance can be undertaken.

In an embodiment, the carriage is configured to be activated at a selected frequency.

In an embodiment, the container comprises a wireless connection device.

In an embodiment, the carriage is remotely operable.

### Lifting Mechanism

In an embodiment, the carriage comprises a lifting mechanism.

In an embodiment, the lifting mechanism is remotely operable.

In an embodiment, the lifting mechanism is configured to raise and lower items between an interior and an exterior of the container.

In an embodiment, the lifting mechanism is configured to remove and replace at least one of the media cages, collector ramp, chute and strainer basket.

In an embodiment, the lifting mechanism comprises a lifting frame having a proximal end and a distal end.

In an embodiment, the lifting frame is pivotally attached at the proximal end to the carriage.

In an embodiment, the lifting frame comprises a cable guide affixed to the distal end.

In an embodiment, the lifting mechanism is configured to operate using a hoist.

In an embodiment, the hoist is configured to be attached to the carriage.

In an embodiment, the hoist is removable.

In an embodiment, the hoist comprises a retractable cable configured to feed through the cable guide and to releasably attach to a lifting point.

In an embodiment, the distal end of the lifting frame is configured to pivot over the proximal end to enable the lifting point to be suspended adjacent to the carriage.

In an embodiment, the cable guide is configured to move laterally on the distal end of the lifting frame, enabling the cable to attach to laterally spaced lifting points.

Alternatively, the lifting mechanism comprises a pivotable crane affixed to the carriage, so that the lifting point can be suspended away from the container to one side.

### Inspection Access Device

In an embodiment, the carriage is configured to support a moveable inspection access device.

In an embodiment, the inspection access device is a ladder.

In an embodiment, the inspection access device is a platform.

In an embodiment, the platform comprises a stair or ladder.

In an embodiment, the inspection access device is mounted external to the container on one of the side walls, and is moveable along the length of the container.

In an embodiment, a top end of the inspection access device is removably attached to the carriage, and a bottom end of the inspection access device is configured to move slidably with respect to the container.

### Harvester

In an embodiment, the harvester system comprises a skimmer affixed to the carriage.

In an embodiment, the skimmer comprises a frame supporting a screen.

In an embodiment, the screen is solid, to enable collection of small particles of biomass.

According to another aspect, the screen is permeable and configured to allow simultaneous passage of water and collection of floating biomass.

In an embodiment, the skimmer is affixed to the carriage with an articulated arm that enables the vertical position of the skimmer to be moveable between a lowermost position and an uppermost position.

In an embodiment, the articulated arm is configured to retain the orientation of the skimmer while the vertical position is moveable between a lowermost position and an uppermost position, so that optimal orientation is ensured at different vertical positions.

In an embodiment, the skimmer is further configured to move up and over the carriage to a maintenance position, to provide overhead access to beneath the carriage.

In an embodiment, the screen comprises apertures no larger than 0.9 mm.

In an embodiment, the screen comprises apertures no larger than 0.5 mm.

In an embodiment, the container comprises a collector ramp proximal the second end wall.

In an embodiment, the skimmer is configured to be moved towards an uppermost position in response to contact with the ramp as the carriage moves toward the second end wall of the container.

In an embodiment, the skimmer is downwardly biased to return to a lowermost position as the carriage is withdrawn from the ramp.

Alternatively, the skimmer is not biased and returns to a lowermost position as the carriage is withdrawn from the ramp due to gravity.

In an embodiment, the skimmer is between 1.55 and 1.95 metres wide.

In an embodiment, the skimmer comprises a scooped profile.

In an embodiment, the ramp is of substantially constant width, wherein the width is between 1.55 and 1.95 metres.

In an embodiment, the ramp comprises raised sidewalls.

In an embodiment, the skimmer comprises wheels mounted to a lower edge of the frame.

In an embodiment, the skimmer comprises a brush mounted to a lower edge of the frame.

In an embodiment, the skimmer further comprises a brush mounted to each side of the frame.

In an embodiment, a nominal gap between the frame and each adjacent surface of the ramp is no larger than 25 mm.

In an embodiment, each brush is between 25 and 50 mm long.

In an embodiment, each brush is configured to resiliently deform under contact with the ramp.

In an embodiment, the ramp is removeable from the container.

In an embodiment, the ramp comprises lugs configured to connect to a lifting mechanism.

In an embodiment, an upper edge of the second end wall of the container is lower than upper edges of the side walls.

In an embodiment, the container comprises a stowable chute.

In an embodiment, the chute comprises a first end and a second end, wherein the first end is slightly wider than the ramp, to ensure effective collection of biomass directed up the ramp.

In an embodiment, the chute is moveable between a stowed configuration and an operable configuration, wherein, when in the stowed configuration, the chute is stowed inside the container against the second end wall and, when in the operable configuration, the second end of the chute is outside the container and extends away from the second end wall.

In an embodiment, the first end of the chute is pivotally affixed to the second end wall of the container, so that the chute is pivotable between the stowed configuration and the operable configuration.

In an embodiment, the chute is further moveable to a transport configuration, in which the chute is located inside the container, above the ramp, and does not project above upper edges of the side walls.

In an embodiment, the chute comprises a strainer basket removably attached proximal the second end of the chute, wherein the strainer basket is configured to catch collected biomass and permit drainage of water therefrom.

In an embodiment, the harvester system comprises an extractor affixed to the carriage.

In an embodiment, the extractor is affixed to the carriage with the articulated arm.

In an embodiment, the extractor comprises a rotating head.

In an embodiment, the extractor comprises a cutting head.

In an embodiment, the extractor comprises a rake.

In an embodiment, the extractor is configured to be attached to the skimmer using an adaptor to enable harvesting of biomass.

Alternatively, the skimmer comprises an extractor suitable for harvesting of biomass.

In an embodiment, the rake comprises a series of tines spaced laterally across the container.

In an embodiment, the tines protrude from the frame of the skimmer.

In an embodiment, the frame comprises tines protruding from one edge, and brushes protruding from an opposed edge.

In an embodiment, the frame is reversibly attached to the articulated arm.

Alternatively, the tines protrude from a bar affixed to the articulated arm.

Preferably, the tines are spaced and/or are of a length suitable for harvesting a selected portion or quantity of biomass from the water.

In an embodiment, the adaptor comprises a basket for capture of all or a portion of the harvested biomass.

In an embodiment, the basket has a release mechanism to enable emptying of the harvested biomass onto the chute.

In an embodiment, the basket is articulated to enable emptying of the harvested biomass onto the chute.

### Internal Chambers

In an embodiment, the container comprises a plurality of chambers configured to provide separable portions for at least partial retention of media.

In an embodiment, the chambers are configured to provide portions separated along a length of the container.

In an embodiment, the chambers are configured to provide portions separated across a width of the container.

In an embodiment, the chambers are configured to provide portions separated in layers within the container.

In an embodiment, the chambers are configured to provide portions separated along a length of the container and in layers within the container.

In an embodiment, the chambers are configured to provide portions separated along a length and width of the container and in layers within the container.

In an embodiment, the chambers are comprised of cages.

In an embodiment, the chambers are comprised of interconnected tanks.

In an embodiment, the chambers are comprised of a combination of cages and interconnected tanks.

According to aspects comprising interconnected tanks, the interconnected tanks are arranged in layers supported within the container.

In an embodiment, the interconnected tanks are arranged to enable a plurality of water and media configurations to be supported within the container.

In an embodiment, at least one of the tanks is a closed tank.

In an embodiment, at least one of the tanks has an open top.

In an embodiment, the interconnected tanks are arranged in layers, wherein the tanks of the upper layer have open tops, and the tanks of lower layers are closed.

In an embodiment, an upper layer of open top tanks forms a green roof.

According to aspects in which at least one of the chambers comprises a cage, the cage is configured to retain plant-based filtration media in a body of water, wherein the water has a direction of flow, wherein the cage is cuboid in shape having six rectangular faces and further comprises a lifting point, wherein the faces comprise; a pair of opposed upper and lower plates, a pair of opposed side walls and a pair of opposed end walls, wherein one of the faces is releasably openable, wherein one of the pairs of opposed faces are permeable, and wherein the cage is configured to be oriented in the body of water with the direction of flow normal to the permeable faces.

In an embodiment, the lower plate is hingably connected to either a side wall or an end wall, and wherein the lower plate comprises a locking mechanism to retain the lower plate in a closed configuration, so that the lower plate can be allowed to swing into an open configuration upon release of the locking mechanism.

In an embodiment, the lower plate is fixed to both the side walls and the end walls, wherein the cage further comprises a pivot mechanism affixed to each of the side walls, wherein the upper plate is hingably connected to either a side wall or an end wall, and wherein the upper plate comprises a locking mechanism to retain the upper plate in a closed configuration, so that the cage can be rotated until the upper plate is facing substantially downwards, and the upper plate can then be allowed to swing into an open configuration upon release of the locking mechanism.

In an embodiment, the pivot mechanism comprises a rotation lock, so that the cage can be secured in a desired rotational position.

In an embodiment, the upper and lower plates are both permeable.

In an embodiment, the container further comprises a plurality of layers of filtration media, wherein the container is configured to receive a plurality of removable cages located on an uppermost layer of filtration media.

In an embodiment, plant-based filtration media retained by the cage may include bullrush, hemp, woodchips, biochar or other natural biological buoyant sorbents.

In an embodiment, the cage is between 1000 mm and 1400 mm wide, preferably, the cage is between 1040 mm and 1260 mm wide.

In an embodiment, the side walls and end walls are between 100 mm and 300 mm high, preferably the side walls and end walls are between 150 mm and 200 mm high.

In an embodiment, a plurality of cages are arranged in an array, wherein the array substantially spans a width and length of the body of water.

### Header Tank

In an embodiment, the container comprises a header tank.

In an embodiment, the header tank is connected to the fluid inlet, to store contaminated water and provide operational pressure.

In an embodiment, the header tank is configured to direct at least a portion of contaminated water to the green roof.

In an embodiment, the header tank is raisable using a tank lifting device, so that the header tank can be raised to provide operational water pressure.

In an embodiment, the tank lifting device is a scissor lift.

In an embodiment, the tank lifting device is manually operable.

Alternatively, the header tank is fixed and provides operational pressure using a pump.

### Green Wall/Display Face

In an embodiment, the container comprises a plurality of panels mounted to at least one external wall, wherein each panel comprises either, or both, a green wall or a display face.

In an embodiment, where at least one panel supports a green wall, the fluid outlet is configured to direct at least a portion of treated water to the green wall.

In an embodiment, the green wall is configured to receive a growth medium.

In an embodiment, the container open top comprises a green roof.

In an embodiment, the green roof is comprised of an upper layer of a plurality of interconnected tanks, wherein the interconnected tanks are arranged in layers supported within the container.

In an embodiment, at least one side of the container comprises an openable wall to enable access to the interior of the container.

In an embodiment, at least one of the panels is configured to cover at least a portion of the open top of the container during transportation.

In an embodiment, a plurality of the panels are configured to cover the entire open top during transportation.

In an embodiment, the open top is between 2430 mm and 1850 mm wide.

Preferably, the open top is between 2250 mm and 1800 mm wide.

In an embodiment, the opening is covered with a removeable mesh (not shown).

In an embodiment, the mesh comprises apertures no greater than 100 mm across.

In an embodiment, at least one panel is between 400 mm and 2450 mm wide, and 2650 mm and 1650 mm high.

Preferably, at least one panel is between 700 mm and 750 mm wide, and 1950 mm and 1650 mm high.

Alternatively, at least one panel is between 700 mm and 750 mm wide, and 400 mm and 750 mm high.

In an embodiment, at least one of the panels is stored within the container during transportation.

In an embodiment, at least one of the panels comprises the display face configured to face downwards during transportation.

In an embodiment, the display face comprises artwork.

In an embodiment, the display face comprises an interactive screen.

In an embodiment, the display face comprises printed information.

In an embodiment, the display faces of multiple panels are configured to be interconnected.

In an embodiment, interconnected panels form a larger composite or collage image across their respective display faces.

In an embodiment, the display faces of the container are configured to be wirelessly connected to display faces of other containers.

In an embodiment, the interactive screen is configured to enable users to view content particular to the container, and content particular to other connected containers.

In an embodiment, the interactive screen comprises payment means to procure items displayed by one or more display faces.

In accordance with one aspect of the present invention there is provided a method of installing a container configured to treat contaminated water, the container comprising; an open top, a plurality of panels at least partially covering the open top, a fluid inlet, a fluid outlet and an internal tank; wherein treated water is directed to the fluid outlet, the method comprising all of the following steps:
a. Locating the container,
b. Removing the panels from the open top and attaching the panels to at least one external wall of the container,
c. Connecting a source of contaminated water to the fluid inlet.

Preferably, the method further comprises the following steps:
d. Affixing a green wall to the panel,
e. Directing at least a portion of the treated water from the fluid outlet to the green wall.

Preferably, the internal tank is located upon a lifting mechanism, and wherein the method further comprises the following step:
f. Operating the lifting mechanism to raise the internal tank to provide operational water pressure.

In accordance with another aspect of the present invention, there is provided a method of replacing plant based absorbent filtration media in a container, wherein the container comprises an open top, and inlet for receiving untreated water and an outlet for egress of treated water, wherein the container is configured to contain; a body of water having a downward direction of flow and a plurality of layers of filtration media; wherein an uppermost layer of filtration media is contained in a plurality of removable cages, wherein each cage is cuboid in shape having six rectangular faces and further comprises a lifting point, wherein the faces comprise; a pair of opposed upper and lower plates, a pair of opposed side walls and a pair of opposed end walls, wherein the upper and lower plates are permeable, wherein the cage further comprises a pivot mechanism affixed to each of the side walls, wherein the lower plate is fixed to both the side walls and the end walls, wherein the upper plate comprises a locking mechanism and is hingably connected to either a side wall or an end wall and is moveable between a closed configuration and an open configuration, the method comprising all of the following steps:
a. Attaching a lifting mechanism to the lifting point of a cage,
b. Raising the cage above the top of the container,
c. Moving the cage laterally until the cage is suspended adjacent to the container,
d. Rotating the cage so that the upper plate is facing substantially downwards,
e. Releasing the locking mechanism, enabling the upper plate to fall into the open configuration and the media to fall from the cage,
f. Rotating the cage so that the lower plate is facing substantially downwards,
g. Lowering the cage to rest on the lower plate,
h. At least partially filling the cage with plant-based filtration media,
i. Moving the upper plate into the closed configuration,
j. Securing the upper plate with the locking mechanism,
k. Raising the cage above the top of the container,
l. Moving the cage laterally until it is suspended over its original location,
m. Lowering the cage back to its original location,
n. Repeating the preceding steps for any further cages requiring replacement of filtration media.

Preferably, at step d. a rotation lock is engaged to retain the cage with the upper plate facing substantially downwards, and at step f. the rotation lock is released to enable the cage to be rotated so that the lower plate is facing substantially downwards.

In accordance with another embodiment of the present invention, there is provided a method of replacing plant based absorbent filtration media in a container, wherein the container comprises; a body of water, an open top, and inlet for receiving untreated water, an outlet for egress of treated water and a plurality of connection points located above a water level, wherein the container is configured to contain a plurality of layers of filtration media; wherein the body of water has a downward direction of flow, wherein an uppermost layer of filtration media is contained in a plurality of removable cages, wherein each cage is cuboid in shape having six rectangular faces, wherein the faces comprise; a pair of opposed upper and lower plates, a pair of opposed side walls and a pair of opposed end walls, wherein the upper and lower plates are permeable, wherein each cage further comprises; a lifting point attached to a first end of a cable, wherein a second end of the cable is configured to releasably connect to a connection point, a pivot mechanism affixed to each of the side walls, wherein the lower plate is fixed to both the side walls and the end walls, wherein the upper plate comprises a locking mechanism and is hingably connected to either a side wall or an end wall and is moveable between a closed configuration and an open configuration, the method comprising all of the following steps:
a. disconnecting the second end of the cable from a connection point and attaching to a lifting mechanism,
b. Raising the cage above the top of the container,
c. Moving the cage laterally until the cage is suspended adjacent to the container,
d. Rotating the cage so that the upper plate is facing substantially downwards,
e. Releasing the locking mechanism, enabling the upper plate to fall into the open configuration and the media to fall from the cage,
f. Rotating the cage so that the lower plate is facing substantially downwards,
g. Lowering the cage to rest on the lower plate,
h. At least partially filling the cage with plant-based filtration media,
i. Moving the upper plate into the closed configuration,
j. Securing the upper plate with the locking mechanism,
k. Raising the cage above the top of the container,
l. Moving the cage laterally until it is suspended over its original location,
m. Lowering the cage back to its original location,
n. Disconnecting the second end of the cable from the lifting mechanism and re-attaching to a connection point,
o. Repeating the preceding steps for any further cages requiring replacement of filtration media.

Preferably, at step d. a rotation lock is engaged to retain the cage with the upper plate facing substantially downwards, and at step f. the rotation lock is released to enable the cage to be rotated so that the lower plate is facing substantially downwards.

In accordance with another embodiment of the present invention, there is provided a method of replacing plant based absorbent filtration media in a cage located in a body of water, wherein the water has a direction of flow, wherein the cage is cuboid in shape having six rectangular faces and further comprises a lifting point and a pivot mechanism, wherein the lifting point is attached to a first end of a cable, wherein a second end of the cable is configured to releasably connect to a connection point located on or above a water level, wherein the faces comprise; a pair of opposed upper and lower plates, a pair of opposed side walls and a pair of opposed end walls, wherein one of the faces is releasably openable, wherein one of the pairs of opposed faces are permeable, and wherein the cage is configured to be oriented in the body of water with the direction of flow normal to the permeable faces, wherein the pivot mechanism is affixed to the opposed side walls, wherein the upper plate is hingably connected to either a side wall or an end wall, and wherein the upper plate comprises a locking mechanism to retain the upper plate in a closed configuration, the method comprising all of the following steps:
a. Disconnecting the second end of the cable from the connection point and attaching to a lifting mechanism,
b. Raising the cage above the body of water,
c. Moving the cage laterally until the cage is suspended adjacent to the body of water,
d. Rotating the cage so that the upper plate is facing substantially downwards,
e. Releasing the locking mechanism, enabling the upper plate to fall into the open configuration and the media to fall from the cage,
f. Rotating the cage so that the lower plate is facing substantially downwards,
g. Lowering the cage to rest on the lower plate,
h. At least partially filling the cage with plant based absorbent filtration media,
i. Moving the upper plate into the closed configuration,
j. Securing the upper plate with the locking mechanism,
k. Raising the cage above the body of water,
l. Moving the cage laterally until it is suspended over the body of water,
m. Lowering the cage back into the body of water,
n. Disconnecting the second end of the cable from the lifting mechanism and re-attaching to the connection point,
o. Repeating the preceding steps for any further cages requiring replacement of filtration media.

Preferably, at step d. the rotation lock is engaged to retain the cage with the upper plate facing substantially downwards, and at step f. the rotation lock is released to enable the cage to be rotated so that the lower plate is facing substantially downwards.

In accordance with another embodiment of the present invention, there is provided a method of replacing plant-based filtration media in a cage located in a body of water, wherein the water has a direction of flow, wherein the cage is cuboid in shape having six rectangular faces and further comprises a lifting point and a locking mechanism, wherein the faces comprise; a pair of opposed upper and lower plates, a pair of opposed side walls and a pair of opposed end walls, wherein one of the faces is releasably openable, wherein one of the pairs of opposed faces are permeable, and wherein the cage is configured to be oriented in the body of water with the direction of flow normal to the permeable faces, the method comprising all of the following steps:
a. Attaching a lifting mechanism to the lifting point of a cage,
b. Raising the cage above the body of water,
c. Moving the cage laterally until the cage is suspended adjacent to the body of water,
d. Rotating the cage so that the upper plate is facing substantially downwards,
e. Releasing the locking mechanism, enabling the upper plate to fall into the open configuration and the media to fall from the cage,
f. Rotating the cage so that the lower plate is facing substantially downwards,
g. Lowering the cage to rest on the lower plate,
h. At least partially filling the cage with plant-based filtration media,
i. Moving the upper plate into the closed configuration,
j. Securing the upper plate with the locking mechanism,
k. Raising the cage above the body of water,
l. Moving the cage laterally until it is suspended over its original location,
m. Lowering the cage back to its original location,
n. Repeating the preceding steps for any further cages requiring replacement of filtration media.

Preferably, at step d. the rotation lock is engaged to retain the cage with the upper plate facing substantially downwards, and at step f. the rotation lock is released to enable the cage to be rotated so that the lower plate is facing substantially downwards.

In accordance with another embodiment of the present invention, there is provided array of containers configured to treat contaminated water, wherein each container comprises an open top, a fluid inlet and a fluid outlet, wherein contaminated water is received by the fluid inlet of a first container, and treated water is directed to the fluid outlet.

In an embodiment, the outlet of each container, with the exception of the final container in the array, is configured to direct water to the inlet of another container in the array.

### BRIEF DESCRIPTION OF DRAWINGS

In order to provide a better understanding, embodiments of the present invention will be described, by way of example only, with reference to the accompanying drawings, in which:

FIG. 1 is a perspective view of a container according to an embodiment of the present invention.

FIG. 2 is a plan view of a container according to an embodiment of the present invention.

FIG. 3a is a section showing a container according to an embodiment of the present invention, with the carriage located toward a first end.

FIG. 3b is a section showing a container according to an embodiment of the present invention, with the carriage located so that the skimmer is in contact with a lower edge of the ramp.

FIG. 3c is a section showing a container according to an embodiment of the present invention, with the carriage located so that the skimmer is in contact with an upper edge of the ramp.

FIG. 4 is a section showing a container according to an embodiment of the present invention, with the lifting mechanism in the operable configuration removing the ramp.

FIG. 5 is a section showing a container according to an embodiment of the present invention, with the chute and lifting mechanism in the stowed configuration for transportation.

FIG. 6a is a section of a container according to an embodiment of the present invention, showing a cage being lifted out of the container by the lifting mechanism.

FIG. 6b is a section of a container according to an embodiment of the present invention, showing the lifting mechanism raising the cage above the container.

FIG. 6c is a section of a container according to an embodiment of the present invention, showing a cage being suspended beyond the end of the container.

FIG. 6d is a section of a container according to an embodiment of the present invention, showing a cage opened, so that filtration media is released.

FIG. 6e is a section of a container according to an embodiment of the present invention, showing a cage being loaded with fresh filtration media.

FIG. 7 is a top view of the second end of the container, showing the carriage with access device attached.

FIG. 8 is an elevation showing a side of the container with the inspection access device affixed.

FIG. 9a is an isometric view showing the carriage arrangement, with the harvester in the operable configuration, and the lifting mechanism in the stowed configuration.

FIG. 9b is an isometric view showing the carriage arrangement, with the harvester in the operable configuration, and the lifting mechanism in the stowed configuration, further showing an extractor attached in front of the skimmer.

FIG. 10 is an isometric view showing the carriage arrangement, with the harvester in the stowed configuration, and the lifting mechanism pivoting into the operable configuration.

FIG. 11 is an isometric view showing the carriage arrangement, with the harvester in the stowed configuration, and the lifting mechanism in the operable configuration.

FIG. 12 is an isometric view showing the carriage arrangement, with the harvester in the operable configuration, the lifting mechanism in the stowed configuration, with the harvester operation underway, and the skimmer close to the ramp.

FIG. 13 is an isometric view showing the carriage arrangement, with the harvester in the operable configuration, the lifting mechanism in the stowed configuration, with the harvester operation underway, and the skimmer in the uppermost position in response to contact with the ramp.

FIG. 14 is a section through a container according to an embodiment of the present invention, the configuration shown having a header tank and a plurality of interconnected tanks.

FIG. 15 is a section through a container according to an embodiment of the present invention, the configuration shown having a header tank and a plurality of interconnected tanks.

FIG. 16 is a section through a container according to an embodiment of the present invention, the configuration shown having a header tank and a plurality of interconnected tanks.

FIG. 17 is an isometric view of a cage according to an embodiment of the present invention, showing the cage in a closed configuration.

FIG. 18 is an isometric view of a cage according to an embodiment of the present invention, showing the cage in an open configuration.

FIG. 19 is an isometric view of a cage according to an embodiment of the present invention, showing the cage rotated with the upper plate in an open configuration.

FIG. 20 is an isometric view of a front of a container according to an embodiment of the present invention, showing a plurality of panels comprising a green wall installed on the panel.

FIG. 21 is an elevation of one side of the container, showing the panels comprising a green wall and display faces, and the header tank in the raised configuration.

### DESCRIPTION OF EMBODIMENTS

Referring to the Figures, there is shown a container 10 configured to treat contaminated water, the container 10 comprising; an open top, a fluid inlet 20, a fluid outlet 25, wherein contaminated water is received by the fluid inlet, and treated water is directed to the fluid outlet.

The contaminated water is treated by phytoremediation of biomass, which is optimally achieved with available sunlight, so the container advantageously requires an open top.

The biomass may be macrophytic biomass, which may be either free-floating or attached to substrate.

Also referring to the Figures, there is provided a container 10 configured to contain a body of water and floating biomass, the container 10 comprising; a pair of side walls 16, a first end wall 12, a second end wall 14, a top 18 having an opening, and a carriage 80 configured to move along a length of the container 10, wherein the carriage 80 comprises a harvester system 90 configured to harvest at least a portion of the floating biomass.

Also referring to the Figures, there is provided a container 10 for treating contaminated water using biomass, the container 10 comprising an open top, a fluid inlet 20 and a fluid outlet 25 and a carriage 80 configured to move along a length of the container 10, wherein the carriage comprises a harvester system 90 configured to harvest at least a portion of the biomass and wherein contaminated water is received by the fluid inlet 20, and treated water is directed to the fluid outlet 25.

The container may comprise a pair of side walls 16, a first end wall 12 and a second end wall 14.

The carriage 80 may be mounted upon rails affixed to the container 10.

The carriage 80 may be configured to be driven by a motor (not shown).

The container 10 may comprise a power supply (not shown).

The container 10 may comprise an energy store (not shown).

The power supply may be configured to charge the energy store.

The energy store may be configured to power the motor.

The carriage 80 may be configured to connect to a charging dock (not shown) proximal a first end wall 12 of the container 10, where the container 10 comprises the power supply and wherein the carriage 80 comprises the energy store and motor, so that the motor may drive the carriage 80 when required, returning the carriage 80 to the charging dock when not in use.

The container 10 may comprise a pump 186, configured to direct water from the body of water, either to the fluid outlet, or to re-circulate back to the body of water.

The container 10 may comprise a dosing tank 182, configured to dose the contaminated water received at the fluid inlet 20, to supplement the process.

The container 10 may further comprise a secondary internal tank 184 configured to receive treated or partially treated water and enables storage and control feed of this water within the treatment or re-use process.

The additional storage capacity may be particularly beneficial where an array of containers 10 is used, for example where one container 10 is operating at a greater throughput than a subsequent container 10 in the array, the additional storage capacity provides a means to better control the overall process.

The secondary internal tank 184 may operate in conjunction with the dosing tank 182, for example by offering a means to store at least partially treated water which may then be dosed before being recirculated, thus providing a means to adjust the composition of the water in the container 10 more effectively during the treatment process.

Any or all of the pump 186, dosing tank 182 and secondary internal tank 184 may be remotely operable.

The container 10 may have at least one fluid inlet 20 and at least one fluid outlet 25 to flush pipework and divert contaminated water generated by the process from the container safely.

The container 10 may comprise a camera 110 to monitor the water surface biomass coverage.

The camera 110 may be mounted to the carriage 80.

The camera 110 may be remotely viewable.

The container 10 may comprise a beacon (not shown) configured to activate before the harvesting operation to warn operators.

The container 10 may comprise a control unit (not shown) configured to activate the carriage 80.

The container 10 may comprise a platform 112 configured to provide a safe location from which maintenance can be undertaken.

The platform 112 may be recessed into the container 10 and configured so that an operator is able to stand upon the platform 112 and access the open top, but wherein the operator is at least partially surrounded by a barrier formed of elements of the container 10.

The carriage 80 may be configured to be activated at a selected frequency.

The container 10 may comprise a wireless connection device.

The carriage 80 may be remotely operable.

In use, a container 10 according to an embodiment of the invention can be transported to the required location.

The location can be anywhere that requires water treatment, for example tailings from a mine site, or urban settings requiring effluent treatment such as an apartment or office building.

Alternative uses may be where water body, such as a lake or river is experiencing high pollution temporarily, for example if a large rain event causes run-off from farmland, increasing pollutants in the river for a period of time.

If required, a number of containers 10 can be installed in an array, with feed of contaminated water directed to the array, to a plurality of containers arrange in sequence or in parallel.

The array may be arranged according to site and treatment requirements, and available space.

Any removeable mesh may be removed to enable the container 10 to be set up into the operable configuration.

Once is the operable configuration, any removeable mesh may then be re-installed to provide safety and prevent operators or wildlife from falling into the container 10.

The mesh may remain in place during operation and may be removed where access is required.

Once configured for operation, the container 10 may be connected to a source of contaminated water.

The contaminated water collects in the container 10 to form the body of water, which reaches a desired depth, or within a desired depth range.

The depth of the water may be selected based on a number of factors, including the required depth for adequate filtration media on the bottom of the container 10, and the appropriate available depth of water above the filtration media to encourage efficient phytoremediation and biomass growth.

In addition, the available sunlight and intensity may dictate that the water level is a particular distance below the lip of the container 10.

The water surface may be propagated with floating biomass, which increases in volume over time, and absorbs contaminants through phytoremediation.

As the volume of biomass increases, the coverage of the biomass over the water surface increases.

### Lifting Mechanism

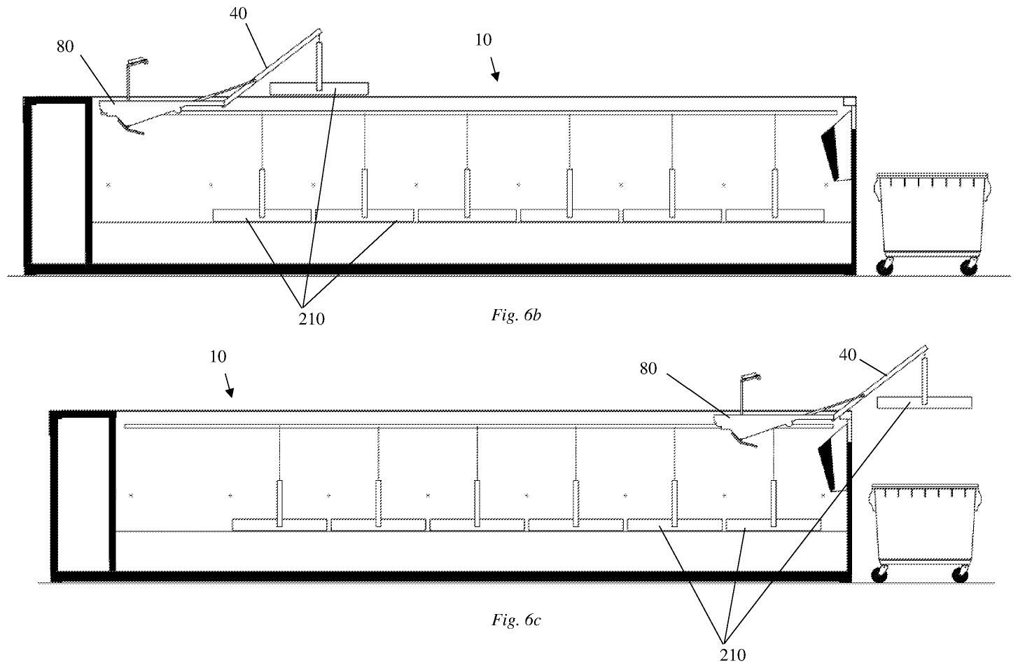

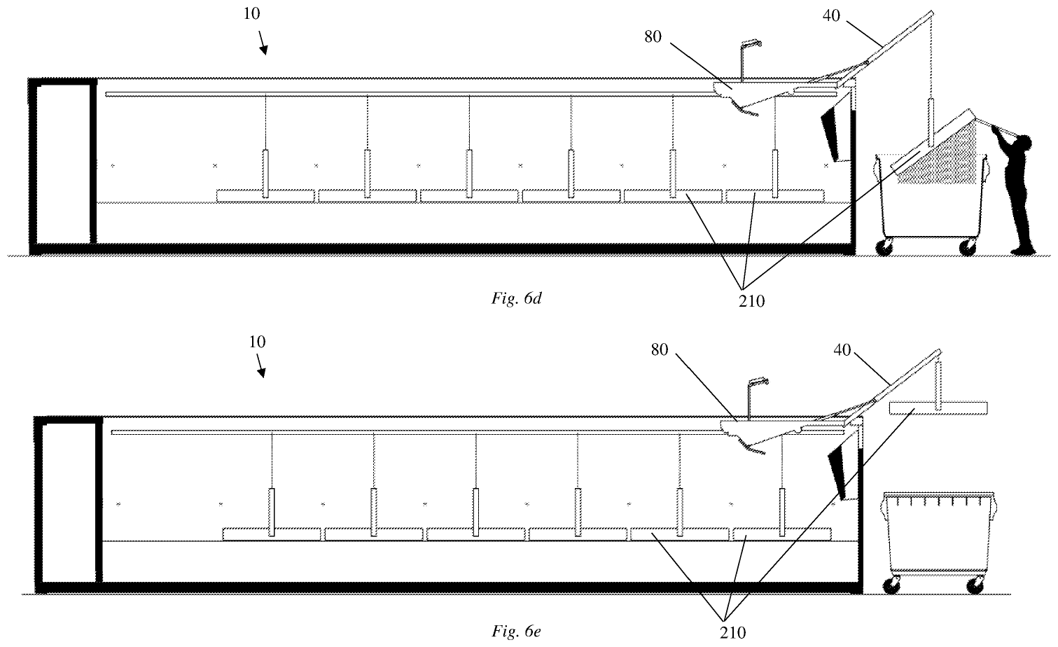

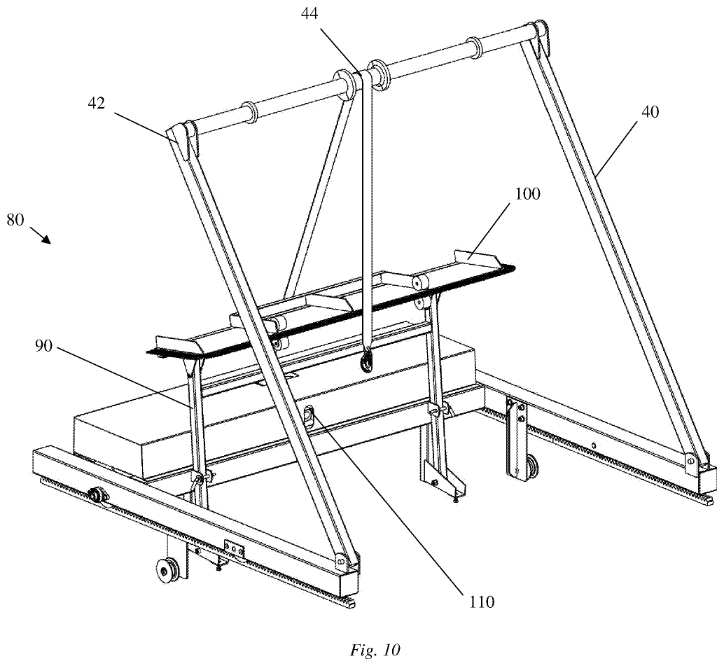

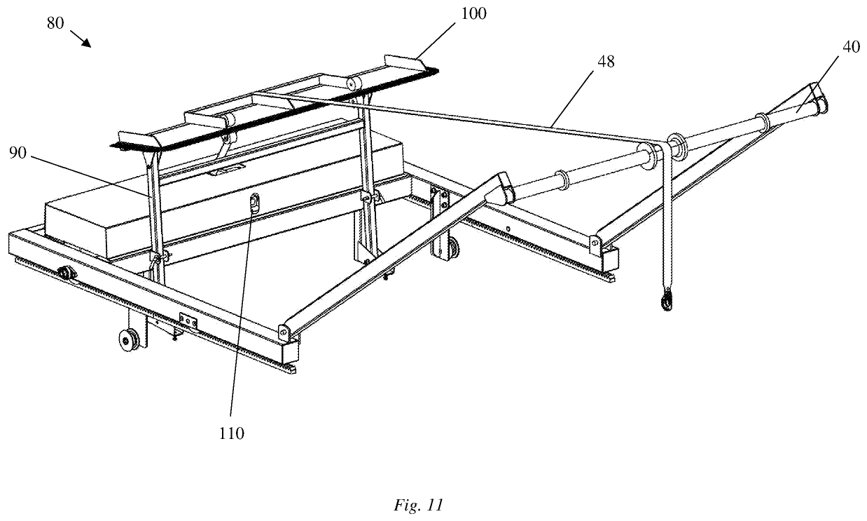

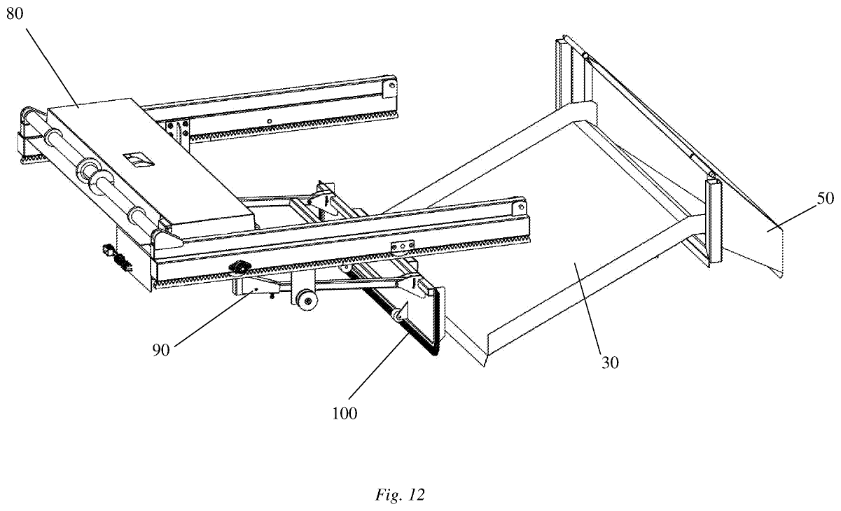

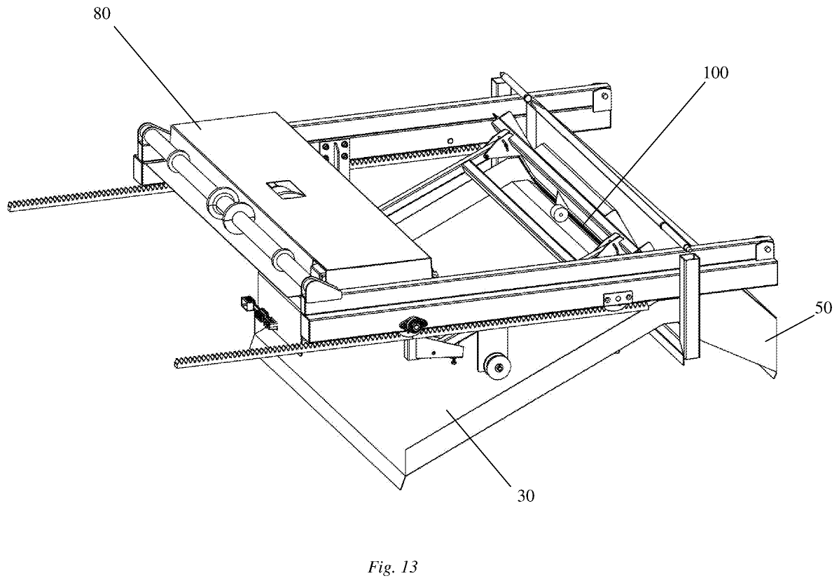

Referring to FIGS. 6a to 6e, 10 and 11, the container 10 may comprise a lifting mechanism 40, the lifting mechanism 40 may be mounted upon the carriage 80 and may be remotely operable.

The lifting mechanism 40 may comprise a hoist 46.

The lifting mechanism 40 may be configured to raise and lower items between an interior and an exterior of the container.

The lifting mechanism 40 may be configured to remove and replace at least one of the media cages 210, collector ramp 30, chute 50 and strainer basket (not shown).

The lifting mechanism 40 may comprise a lifting frame 42 having a proximal end and a distal end.

The lifting frame 42 may be pivotally attached at the proximal end to the carriage 80.

The lifting frame 42 may comprise a cable guide 44 affixed to the distal end.

The lifting mechanism 40 may be configured to operate using a hoist 46.

The hoist 46 may be configured to be attached to the carriage 80.

The hoist 46 may be removable.

The hoist 46 may comprise a retractable cable 48 configured to feed through the cable guide 44 and to releasably attach to the lifting point 260 of a cage 210.

The distal end of the lifting frame 42 may be configured to pivot over the proximal end to enable the cage 210 to be suspended adjacent to the carriage 80, so that the contents of the cage 210 can be unloaded.

The cable guide 44 may be configured to move laterally on the distal end of the lifting frame, enabling the cable 48 to attach to lifting points 260 of laterally spaced cages 210.

Where filtration media or any other contents are required to be added to the container 10, the lifting mechanism 40 may be used to first remove the ramp 30 if required, and then any media cages 210 as required.

Before operating the lifting mechanism 40, any skimmer 100 may be moved over the carriage 80 to the maintenance position, to provide access for the lifting mechanism 40.

Once media cages 210 are prepared with filtration media, the lifting mechanism 40 may be used to replace the media cages 210, and then to install the collector ramp 30.

Alternatively, the lifting mechanism 40 may comprise a pivotable crane affixed to the carriage 80, so that the cage 210 can be suspended away from the container 10 to one side.

Alternatively, the container 10 may comprise no lifting mechanism, and the cages 210 are removeable using an external lifting means, for example a mobile crane.

Such an embodiment is non-preferred, partly due to the requirement to provide such a lifting means, and partly due to the lack of visibility from the operator, who would then require additional personnel to guide the operator to attach the lifting means to the lifting points 60.

### Inspection Access Device

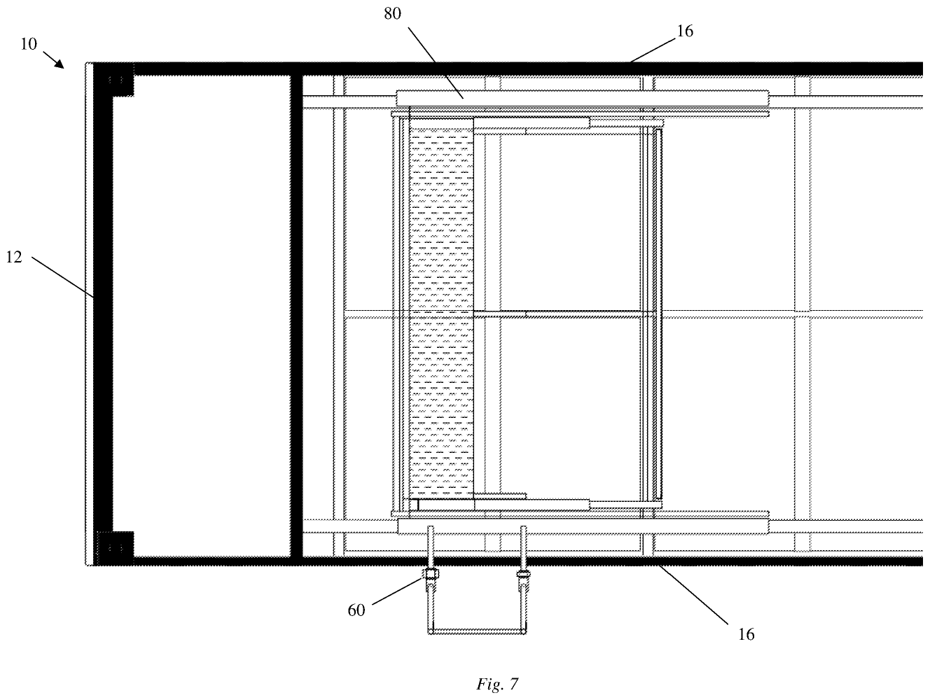

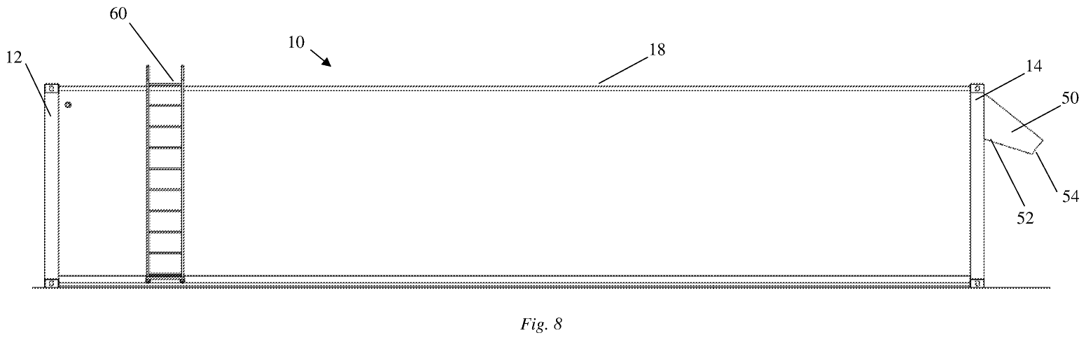

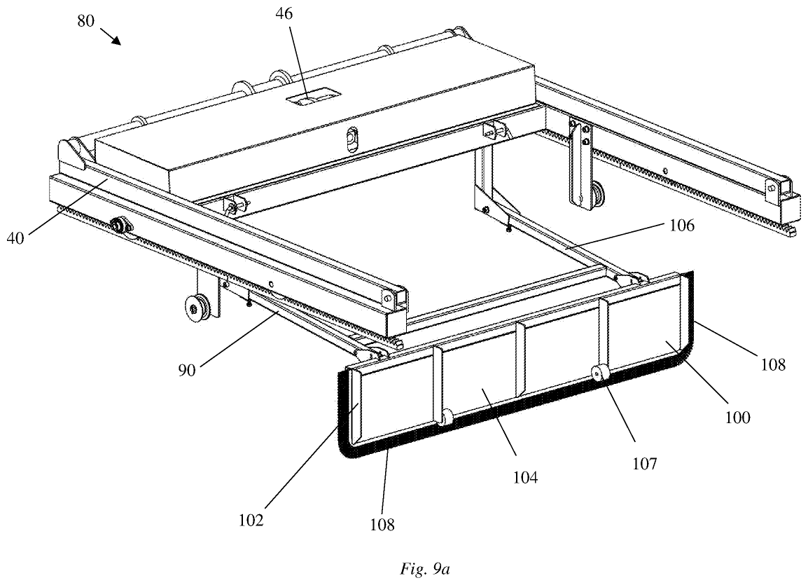

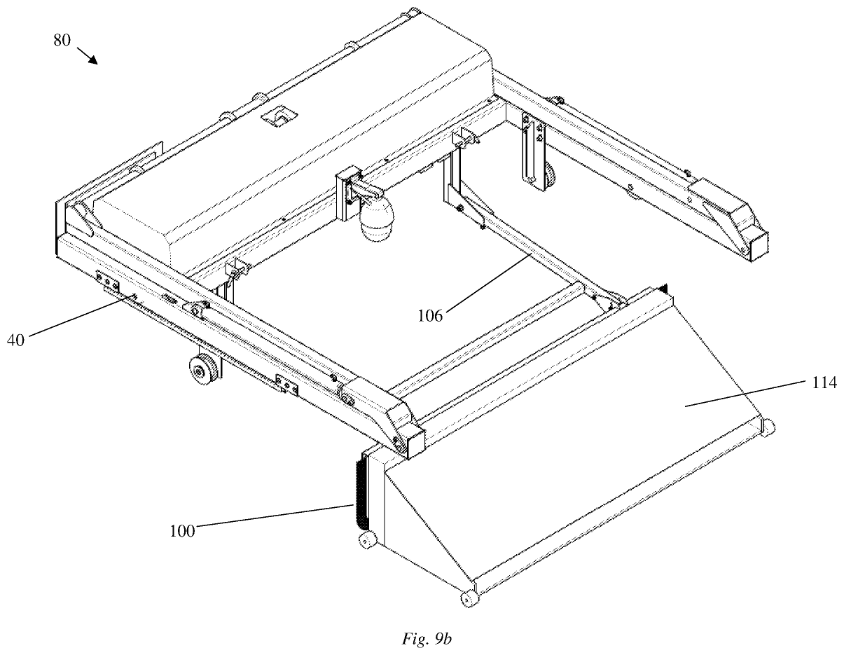

Referring to FIGS. 7 and 8, the carriage 80 may be configured to support a moveable inspection access device 60.

The inspection access device 60 may be a ladder.

The inspection access device 60 may be a platform.

The platform may comprise a stair or ladder to provide access.

The inspection access device 60 may be mounted external to the container 10 on one of the side walls 16, and wherein the inspection access device 60 may be moveable along the length of the container 10.

A top end of the inspection access device 60 may be removably attached to the carriage 80, and a bottom end of the inspection access device 60 may be configured to move slidably with respect to the container 10.

The inspection access device 60 being mounted to the carriage 80 allows access to be provided for inspection and/or maintenance at any location along the length of the container 10.

As the inspection access device 60 may be removably attached to the carriage 80, it is able to be stored either separately or within the container 10 when not in use, thus not protruding from the container 10 and facilitating transportability.

### Harvester System

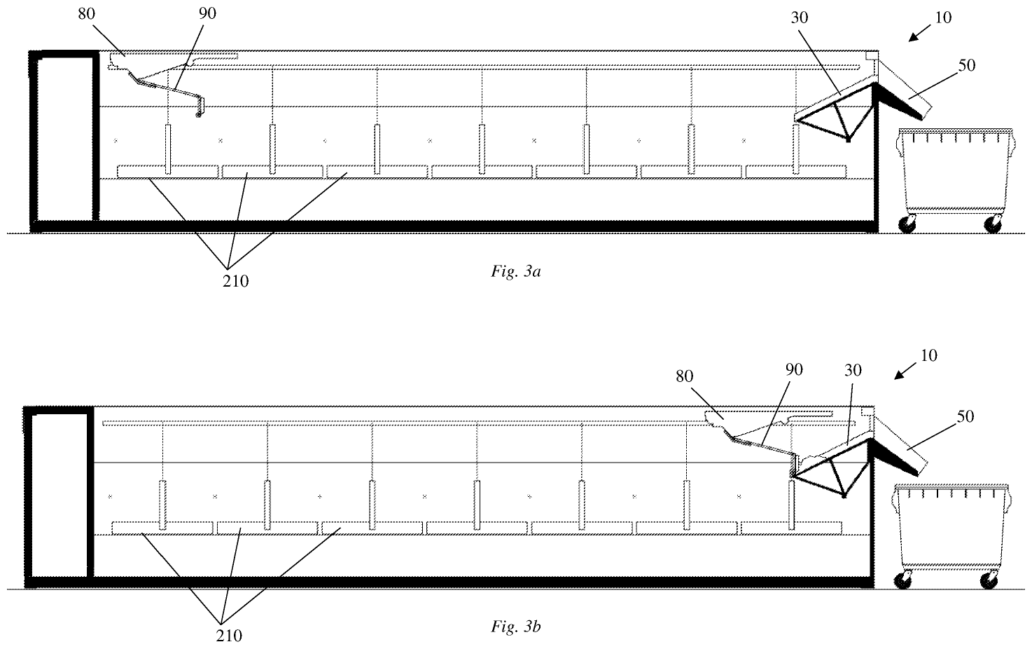

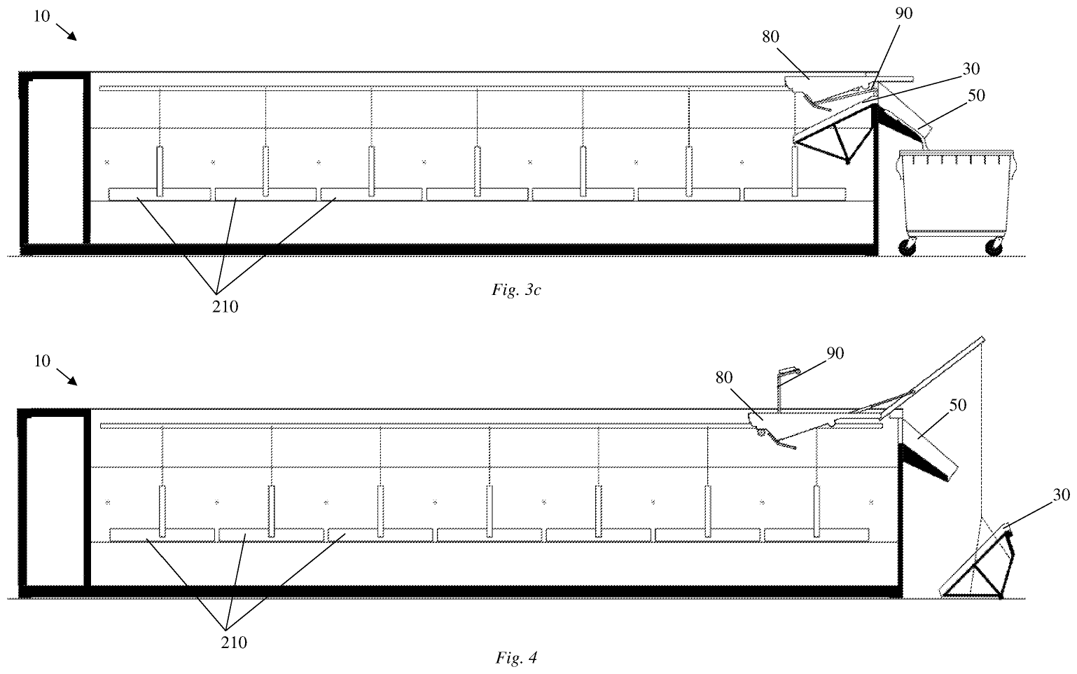

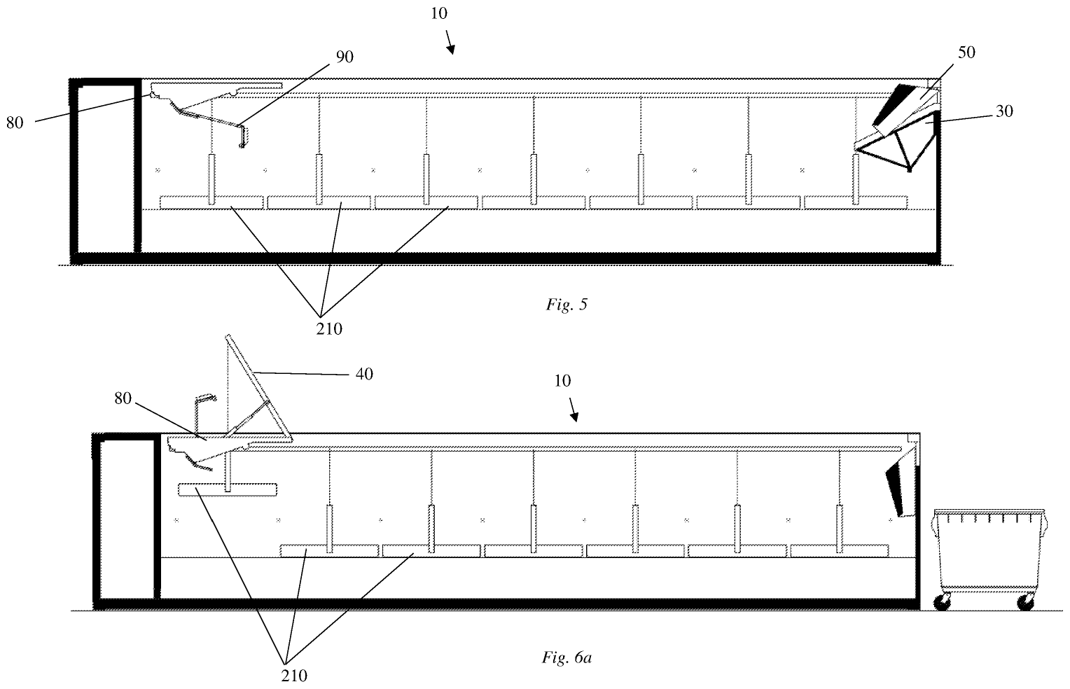

Referring to FIGS. 3a to 3c, 4, 5 and 9 thru 13, the harvester system 90 may comprise a skimmer 100 affixed to the carriage 80.

The skimmer 100 may be affixed to the carriage 80 by an articulated arm 106 that retains the orientation of the skimmer 100 whilst enabling the vertical position of the skimmer 100 to be moveable between a lowermost position and an uppermost position.

The articulated arm 106 may be configured to retain the orientation of the skimmer 100 while the vertical position is moveable between a lowermost position and an uppermost position, so that optimal orientation is ensured at different vertical positions.

The skimmer 100 may comprise a frame 102 supporting a screen 104.

The screen 104 may be solid, to enable collection of small particles of biomass.

Alternatively, the screen 104 may be permeable and configured to allow simultaneous passage of water and collection of floating biomass.

The skimmer 100 may be further configured to move up and over the carriage 80 to a maintenance position, to provide overhead access to beneath the carriage 80.

The screen 104 may comprise apertures no larger than 0.9 mm.

The screen 104 may comprise apertures no larger than 0.5 mm.

The container 10 may comprise a collector ramp 30 proximal the second end wall 14.

The skimmer 100 may be configured to be moved towards an uppermost position in response to contact with the ramp 30 as the carriage 80 moves toward the second end wall 14 of the container 10.

The skimmer 100 may be downwardly biased to return to a lowermost position as the carriage 80 is withdrawn from the ramp 30.

Alternatively, the skimmer 100 may not be biased and returns to a lowermost position as the carriage 80 is withdrawn from the ramp 30 due to gravity.

The skimmer 100 may be between 1.55 and 1.95 metres wide.

The skimmer 100 may comprise a scooped profile to assist with collection of floating biomass.

The ramp 30 may be of substantially constant width, wherein the width is between 1.55 and 1.95 metres.

The ramp 30 may comprise raised sidewalls to prevent loss of harvested biomass.

The skimmer 100 may comprise wheels 107 mounted to a lower edge of the frame 102, the wheels may assist with guiding the frame 102 upon the ramp 30.

The skimmer 100 may comprise a brush 108 mounted to a lower edge of the frame 102.

The skimmer 100 may further comprises a brush 108 mounted to each side of the frame 102.

The brushes 108 may assist with collection of biomass.

A nominal gap between the frame 102 and each adjacent surface of the ramp 30 may be no larger than 25 mm.

Each brush 108 may be between 25 and 50 mm long.

Each brush 108 may be configured to resiliently deform under contact with the ramp 30.

The ramp 30 may be removeable from the container.

The ramp 30 may comprise lugs configured to connect to the lifting mechanism 40.

An upper edge of the second end wall 14 of the container 10 may be lower than upper edges of the side walls 16.

The container 10 may comprise a stowable chute 50, for directing harvested biomass to a collection location.

The chute 50 may comprise a first end 52 and a second end 54, wherein the first end 52 is wider than the ramp 30, to ensure effective collection of biomass directed up the ramp 30.

The chute 50 may be moveable between a stowed configuration and an operable configuration, wherein, when in the stowed configuration, the chute 50 is stowed inside the container 10 against the second end wall 14 and, when in the operable configuration, the second end 54 of the chute 50 is outside the container 10 and extends away from the second end wall 14.

The first end 52 of the chute 50 may be pivotally affixed to the second end wall 14 of the container 10, so that the chute 50 is pivotable between the stowed configuration and the operable configuration.

The chute 50 may further be moveable to a transport configuration, in which the chute 50 is located inside the container 10, above the ramp 30, and does not project above upper edges of the side walls 16.

The chute 50 may comprise a strainer basket (not shown) removably attached proximal the second end 54 of the chute 50, wherein the strainer basket is configured to catch collected biomass and permit drainage of water therefrom.

The harvester system 90 may comprise an extractor 114 affixed to the carriage 80.

The extractor 114 may be affixed to the carriage with the articulated arm 106.

The extractor 114 may comprise a rotating head.

The extractor 114 may comprise a cutting head.

The extractor 114 may comprise a rake.

The extractor 114 may be configured to be attached to the skimmer 100 using an adaptor to enable harvesting of biomass attached or rooted to substrate.

Alternatively, the skimmer 100 may comprise the extractor 114 suitable for harvesting of biomass.

The extractor 114 may comprise a series of tines spaced laterally across a width of the container 100.

The tines may protrude from the frame 102 of the skimmer 100.

The frame 102 may comprise tines protruding from one edge, and brushes 108 protruding from an opposite edge.

The frame 102 may be reversibly attached to the articulated arm 106, so that the frame can be reversed depending on the type of biomass being harvested, free-floating or attached.

Alternatively, the extractor 114 may comprise tines protruding from a frame affixed to the articulated arm 106.

Alternatively, the extractor 114 may comprise tines protruding from a frame affixed to the carriage 80.

The tines may be spaced and/or are of a length suitable for harvesting a selected portion or quantity of biomass.

The harvester system 90 may comprises a basket for capture of all or a portion of the harvested biomass.

The basket may have a release mechanism to enable emptying of the harvested biomass onto the chute 50.

In use, the skimmer 100 and/or extractor 114 may be affixed to the carriage 80 and the height selected so that the frame 102 of the skimmer 100 is partially submerged.

The selected height may be so that the bottom and top edge of the skimmer 100 are at a selected distance below and above the surface of the water.

The selected height may be so that the top of the frame 102 is between 100 mm and 200 mm above the surface of the water.

The selected height may be so that the bottom of the frame 102 is between 100 mm and 200 mm below the surface of the water.

Importantly, the selected height is adjustable to enable the skimmer 100 to operate effectively at different depths of water.

Also importantly, the orientation of the skimmer 100 is kept the same, so that the skimmer 100 remains in the optimal orientation for collection of biomass regardless of the height. Alternatively, in embodiments where the screen 104 is solid, the height may be selected so that the bottom of the frame 102 is no more than 25 mm above the surface of the water.

In embodiments comprising an extractor 114, the extractor 114 may be positioned at a selected height and/or angle, to optimally harvest biomass.

Optimal harvesting of biomass may be to harvest a percentage, rather than all, the biomass present at the time of harvesting. This allows for some biomass to be retained to assist with rapid propagation of more biomass, and therefore accelerated treatment of water.

The percentage of biomass optimally harvested may be between 50% and 75%.

There also exists an optimum frequency for which the biomass should be harvested, the coverage being dependant on various factors, including but not limited to; the contaminant level absorbed in the biomass, the coverage of the water surface and resultant effect on continued phytoremediation, and the level of contaminants present in the water.

The level of contaminant present in the biomass is an important consideration, as harvested biomass can have many uses, such as animal feed or as compost.

Excessive contaminant levels may make the biomass unsuitable for one or more applications and may therefore require harvesting before contaminants present reach such a level.

The container 10 of the present invention is intended to be a zero-waste solution and is it therefore important that the harvested biomass and/or filtration media is reusable and not disposed of.

The phytoremediation process depends in part in sunlight, and the biomass coverage of the water surface affects the level of sunlight reaching the water and therefore affects the efficiency of the phytoremediation process.

It is therefore important that the biomass is harvested at a frequency and water surface coverage level that optimises the efficiency of the process.

The concentration of contaminants in the water can vary greatly, not least because containers 10 according to the present invention can be connected in series, with a fluid outlet 25 of one container 10 connecting to a fluid inlet 20 of an adjacent container 10.

In such arrangements, the contaminants are removed gradually along the arrangement of containers 10, and the levels of contaminant in the water and the biomass differ from one container 10 to the next.

The control unit may be configured to control the frequency at which the harvesting operation occurs.

The container 10 may further comprise sensors to measure at least one of; water contaminant level, biomass contaminant level and water surface coverage.

The control unit may further to be configured to use sensor measurements to perform the harvesting function as required.

To perform the harvesting function, the control unit activates the motor to drive the carriage 80.

Alternatively, the motor may be activated by a user, either by activation means on the container 10, or remotely.

Once activated, the carriage 80 may be driven along the rails attached to the container 10.

The carriage 80 may be driven from proximal the first end wall 12 of the container 10 to proximal the second end wall 14.

As the carriage 80 is driven, the skimmer 100 or extractor 114 passes across the water surface, collecting biomass.

In the case of free-floating biomass the skimmer 100 may be preferred, and in the case where the biomass is at least partially attached to substrate, the extractor 114 may be preferred.

As the skimmer 100 and/or extractor 114 are set at a height which ensures it is adequately above and below the water surface, the biomass is efficiently collected.

As the skimmer 100 and/or extractor 114 reaches the end of the container 10, the lower edge of the frame 102, or the extractor 114, contacts the collector ramp 30.

The extractor 114 may be affixed to the articulated arm 106 in front of the skimmer 100 so that, as the carriage 80 moves along the container 10, the extractor 114 harvests biomass, which are then collected using the skimmer 100.

As the ramp 30 is at an angle, the contact imparts an upward force on the skimmer 100, the upward movement is permitted by the articulated arm 106.

The skimmer 100 and/or extractor 114 therefore pushes collected biomass up the ramp 30 toward the second end wall 14 of the container 10.

The skimmer 100 and/or extractor 114 may include features to assist with efficient design and operation, being wheels 107 and/or brushes 108.

Wheels 107 enable the skimmer 100 to travel up the ramp with reduced friction and assist with overcoming any obstacles which may otherwise cause sticking or malfunction.

Brushes 108 may be used on a bottom edge or side edges, or both, of the frame 102, to assist with the collection of biomass.

The brushes 108 may be of a length greater than the gap between the frame and the adjacent surface of the ramp 30 and may resiliently deform to enable improved collection of biomass.

Upon reaching the end of the ramp 30, the collected biomass is transferred to the first end 52 of the chute 50, at which point the biomass slides down the chute 50 to a collection location below.

After collection, the carriage 80 returns the skimmer 100 and/or extractor 114 to proximal the first end wall 12 of the container 10.

It is important that adequate biomass remains on the water surface for further propagation. If too much biomass is removed, the time to re-grow would impact the efficiency of the system.

To prevent excessive removal of biomass, the width of the skimmer 100 may be determined to only harvest biomass from a certain portion of the water surface.

As the skimmer 100 passes across the water surface, some biomass is allowed to pass the sides of the skimmer and remain in the container 100.

Where an extractor 114 is used, the spacing of the tines and/or the width of the extractor, may be selected to harvest only a desired quantity of biomass.

Furthermore, once the harvesting operation is complete, as the carriage 80 returns to proximal the first end 12 of the container 10, clumped biomass which has not been removed is encouraged to disperse across the water surface once more, to further assist continued propagation.

The motor may be powered by the energy store, which may be charged by the power supply.

In embodiments where the power supply is a generation device, such as a solar panel or wind turbine, the container 10 may be located remote from any infrastructure, and capacity of the power supply and energy store may be determined to provide sufficient power to meet the demands of the container 10.

Solar panels may be integrated with the panels covering the top during transportation and may be then affixed to the sides of the container 10, wherein the sides of the container 10 to which the solar panels are affixed may be selected due to the amount of available sunlight received.

In embodiments where the power supply is an external electrical connection, the motor may be powered directly by the power supply.

As the harvesting operation may be undertaken using a carriage 80 and skimmer 100 and/or extractor 114, there is no requirement for an operator to enter the container 10, or to attempt to remove the biomass using manual means, and the operation is therefore safer.

As the harvesting operation may be undertaken remotely or upon a set frequency, there is no requirement for an operator to be present, and remote operation provides reduced costs and increased efficiency.

### Internal Chambers

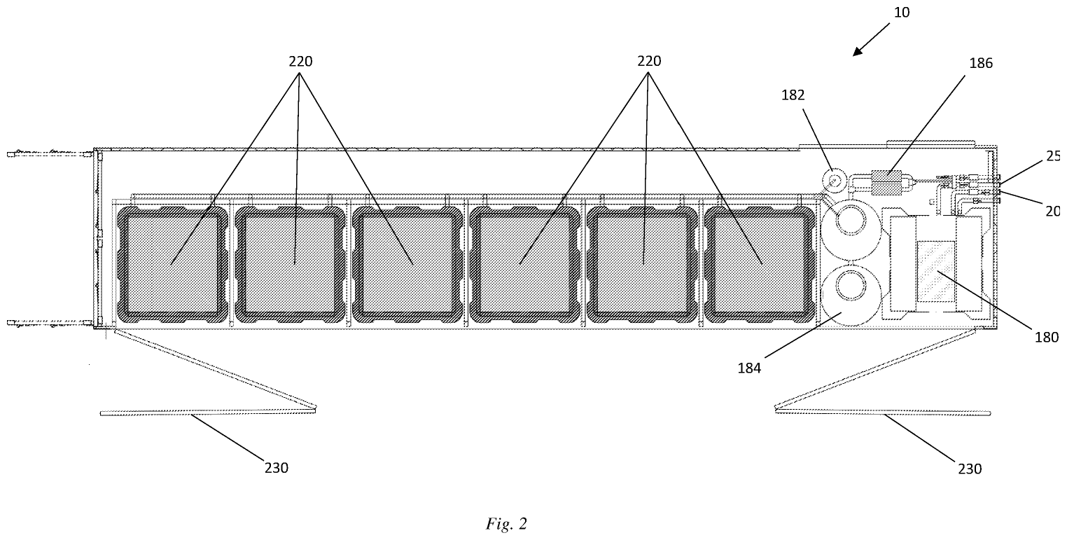

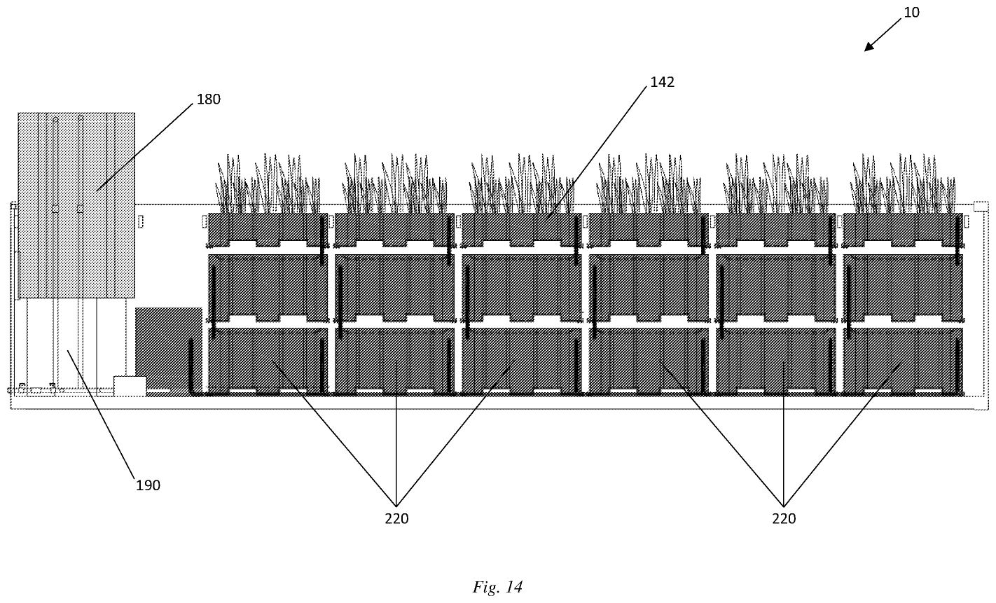

Referring to FIGS. 2 and 14 thru 16, the container 10 may comprise a plurality of chambers 200 configured to provide separable portions for at least partial retention of media.

The chambers 200 may be configured to provide portions separated along a length of the container 10.

The chambers 200 may be configured to provide portions separated across a width of the container 10.

The chambers 200 may be configured to provide portions separated in layers within the container 10.

The chambers 200 may be configured to provide portions separated along a length of the container 10 and in layers within the container 10.

The chambers 200 may be configured to provide portions separated along a length and width of the container 10 and in layers within the container 10.

The different configurations of chambers 200 allow for separability of portions in one, two or three dimensions.

Separable portions allow for the contents to be retained in a particular location within the container, and further allow for the selective removal and/or replacement of contents.

Selective removal and/or replacement makes the process simpler by lowering the mass and volume of contents being removed at one time.

Furthermore, the retention on contents prevents disturbance or mixing of the contents during removal and/or replacement, which may be undesirable.

The chambers 200 may be comprised of cages 210.

The chambers 200 may be comprised of interconnected tanks 220.

The chambers 200 may be comprised of a combination of cages 210 and interconnected tanks 220.

Interconnected tanks 220 may be arranged in layers supported within the container 10.

Interconnected tanks 220 may be arranged to enable a plurality of water and media configurations to be supported within the container 10.

At least one of the interconnected tanks 220 may be a closed tank.

At least one of the interconnected tanks 220 may have an open top.

The interconnected tanks 220 may be arranged in layers, wherein the tanks 220 of the upper layer have open tops, and the tanks 220 of lower layers are closed.

An upper layer of open top interconnected tanks 220 may form a green roof.

Where interconnected tanks 220 are comprised, these may be removed or installed using either the lifting mechanism 40, or other lifting means.

Alternatively, interconnected tanks 220 may be slidably mounted upon rails within the container 10.

Slidably mounted interconnected tanks 220 may be removed and replaced via an openable wall 230 on one side of the container 10.

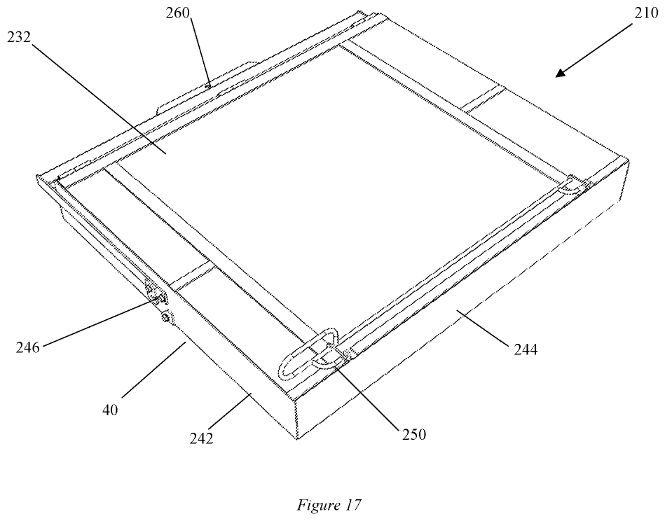

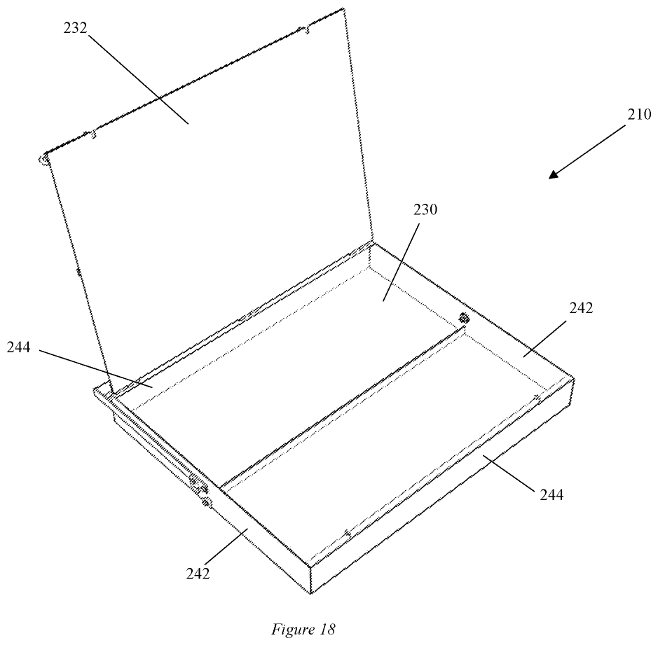

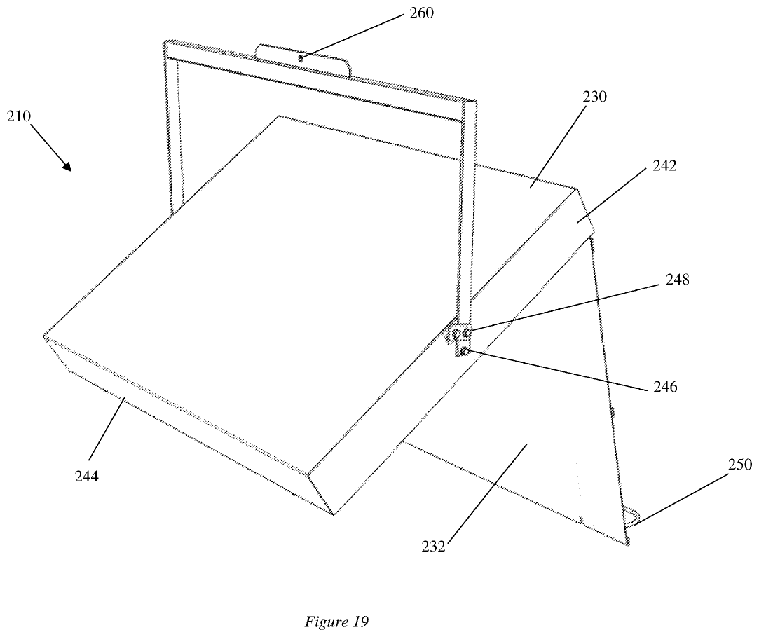

Referring to FIGS. 17 to 19, according to aspects in which at least one of the chambers 200 comprises a cage 210, the cage 210 may be configured to retain plant-based filtration media in a body of water, wherein the water has a direction of flow, wherein the cage 210 is cuboid in shape having six rectangular faces and further comprises a lifting point 260, wherein the faces comprise; a pair of opposed upper 232 and lower 230 plates, a pair of opposed side walls 242 and a pair of opposed end walls 244, wherein one of the faces is releasably openable, wherein one of the pairs of opposed faces are permeable, and wherein the cage 210 is configured to be oriented in the body of water with the direction of flow normal to the permeable faces.

The lower plate 230 may be hingably connected to either a side wall 242 or an end wall 244, wherein the lower plate 230 may comprise a locking mechanism 250 to retain the lower plate 230 in a closed configuration, so that the lower plate 230 can be allowed to swing into an open configuration upon release of the locking mechanism 250.

The lower plate 230 may be affixed to both the side walls 242 and the end walls 244, and the cage 210 may further comprise a pivot mechanism 246 affixed to each of the side walls 242, wherein the upper plate 32 is hingably connected to either a side wall 242 or an end wall 244, and wherein the upper plate 232 comprises a locking mechanism 250 to retain the upper plate 232 in a closed configuration, so that the cage 210 can be rotated until the upper plate 232 is facing substantially downwards, and the upper plate 232 can then be allowed to swing into an open configuration upon release of the locking mechanism 250.

The pivot mechanism 246 may comprise a rotation lock 248, so that the cage 210 can be secured in a desired rotational position.

The upper plate 232 and the lower plate 230 may be permeable.

The container 10 may further comprise a plurality of layers of filtration media, wherein the container 10 is configured to receive a plurality of removable cages 210 located on an uppermost layer of filtration media.

Frequent replacement of the upper layer of filtration media enables less frequent treatment or replacement of subjacent layers of filtration media, thus prolonging the life and reducing the waste produced by the container 10.

The frequency of replacement of the upper level of filtration media may be selected based on a variety of factors, for example but not limited to, measured contaminant level, time elapsed since last replacement and water volume processed.

A plurality of removable cages 210 may additionally be located on one or more subjacent layers of filtration media.

Alternatively, subjacent layers of filtration media may require removal manually and treatment.

Plant-based filtration media retained by the cage 210 may include bullrush, hemp, woodchips, biochar or other natural biological buoyant sorbents.

It is acknowledged that the rectangular form of the faces of the cage 210 may encompass variations in shape, such as rounded corners, whilst remaining within the scope of the invention.

Each cage 210 may be between 1000 mm and 1400 mm wide.

Alternatively, each cage 210 may be between 1040 mm and 1260 mm wide.

The side walls 242 and end walls 244 may be between 100 mm and 300 mm high.

Alternatively, the side walls 242 and end walls 244 may be between 150 mm and 200 mm high.

The plurality of cages 210 may be arranged in an array.

The array may substantially span a width and length of the body of water.

In use, at least one cage 210 may be located in body of water requiring treatment, for example a river, lake, or container.

The permeable faces enable the flow of water through the cage 210.

The content of the cage 210 may be buoyant, and is therefore restrained within the cage 210, thus prevented from being washed away with the water.

In embodiments in which the cage 210 is comprised within a container 10, the container 10 may contain a plurality of layers of filtration media, submerged in the body of water.

In an embodiment, four layers of filtration media are used, with the lowermost three located in the bottom of the container 10, and the fourth, being the uppermost, housed in the cages 210.

Alternative numbers of layers of filtration media are acknowledged to be within the scope of the invention.

The upper layer of filtration media may be contained within a plurality of cages 210, arranged in an array substantially covering the subjacent layer of filtration media and submerged within the body of water.

It is acknowledged that cages 210 could also be used on top of one another, thus forming additional layers of filtration media.

Apertures in one or all of the lower plate 230, upper plate 232 and end walls 244 may be sized to enable drainage of water and retention of media.

Apertures may be between 1 and 15 mm across.

Contaminated water may be fed to the container 10.

The contaminated water collects in the container 10 to form the body of water, which reaches a desired depth, or within a desired depth range, so that all layers of filtration media are submerged.

Contaminants are absorbed from the water over time by the filtration media, both the media in the cages 210, and the media in subjacent layers in the container 10.

Contaminant removal may be achieved through a variety of processes, including but not limited to bio-sorption, bio-remediation or phyto-remediation.

As the media becomes more saturated with contaminants, the efficiency of the process decreases.

Furthermore, once contaminant levels reach a certain level, the media cannot be reused for some applications.

One example of this is a preferred media type, bullrush, which can be used as compost even after being used to treat contaminated water, providing the contaminant levels are within acceptable limits.

The present invention is intended to be a zero-waste system, and as such, re-purposing contaminated filtration media for other uses is desirable.

Once a level of contamination has been reached, the upper layer of filtration media may be removed and replaced according to the methods described herein.

Subjacent layers of filtration media may require removal manually and treatment.

Furthermore, subjacent layers of filtration media may be unsuitable for repurposing, as the contaminant levels may be too high.

Frequent replacement of the upper layer of filtration media enables less frequent treatment or replacement of subjacent layers of filtration media, thus prolonging the life and reducing the waste produced by the container 10.

The frequency of replacement of the upper level of filtration media may be selected based on a variety of factors, for example but not limited to, measured contaminant level, time elapsed since last replacement and water volume processed.

As shown in FIGS. 6a to 6e, filtration media comprised within a plurality of cages 210 may be removed and replaced by first attaching a lifting mechanism 40 to the lifting point 260 of a cage 210.

The lifting mechanism 40 may be attached to the lifting point 260 of the cage 210 using the cable 48.

The cable 48 may alternatively by attached between the lifting point 260 of the cage 210

The cage 210 may then be raised above the top of the container 10, and moved laterally until the cage 210 is suspended adjacent to the container 10.

The cage 210 may then be rotated so that the upper plate 232 is facing substantially downwards, and the locking mechanism 250 may be released, enabling the upper plate 232 to fall into the open configuration and the media to fall from the cage 210.

A rotation lock 248 may be engaged to prevent the cage 210 from swinging uncontrollably when the locking mechanism 250 is released and the media falls.

Means to store the filtration media may be located under the cage 210 before the upper plate 232 is opened, means may include, but is not limited to, a compost bin, a simple tarpaulin or a trailer or back of a ute.

Opening of the upper plate and rotation of the cage allows for simple emptying of the media, which would otherwise need to be scooped from the cage.

It is preferable to have the upper plate 232 be openable, rather than the lower plate 230, which reduces the impact and likelihood of the cage 210 opening accidentally. Such accidental opening could result in injury, or in uncontained media on the floor of the container 10.

Once empty, the cage 210 can be rotated so that the lower plate 230 is facing substantially downwards, and the cage 210 can be lowered to rest the lower plate 30 on ground or other substrate. If a rotation lock 248 has been engaged, it should be released to enable the rotation of the cage 210 once more.

Resting the cage 210 on ground allows for a stable structure in which new filtration media can be loaded, whereas loading a suspended cage 210 could be dangerous.

Once filled with fresh filtration media, the upper plate 232 can be moved into the closed configuration and secured with the locking mechanism 250.

The cage 210 can then be raised above the top of the container 10, moved laterally until it is suspended over its original location, and lowered back to its original location.

The same process can be repeated for any further cages 210 requiring replacement of filtration media.

Sufficiently frequent replacement of plant based absorbent filtration media enables the contaminated media to be repurposed, providing the contamination has not reached a level which makes it unsuitable for such further use.

### Header Tank

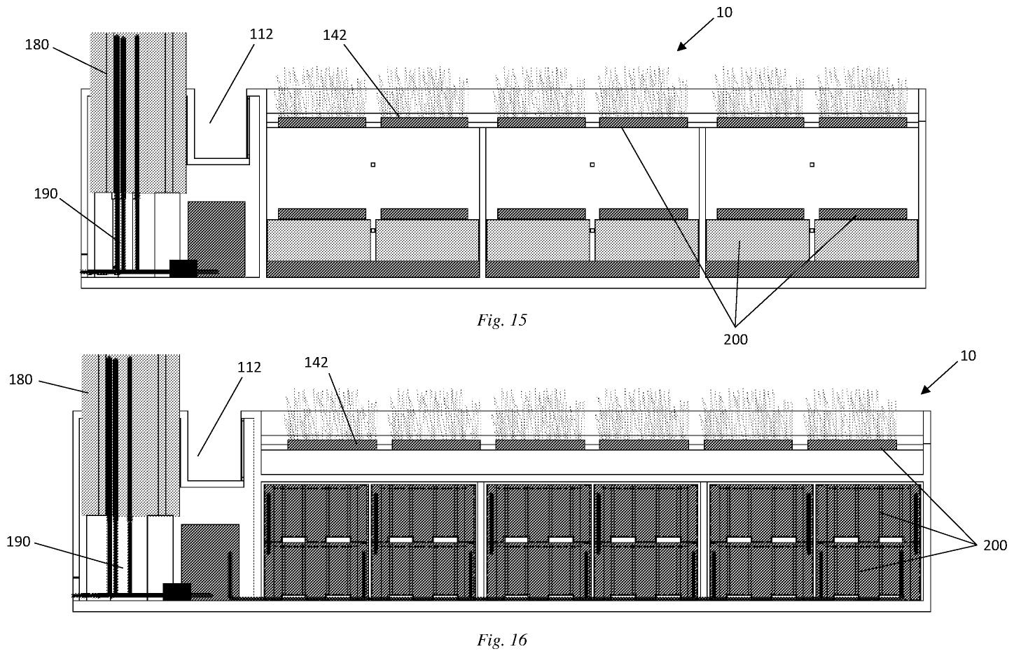

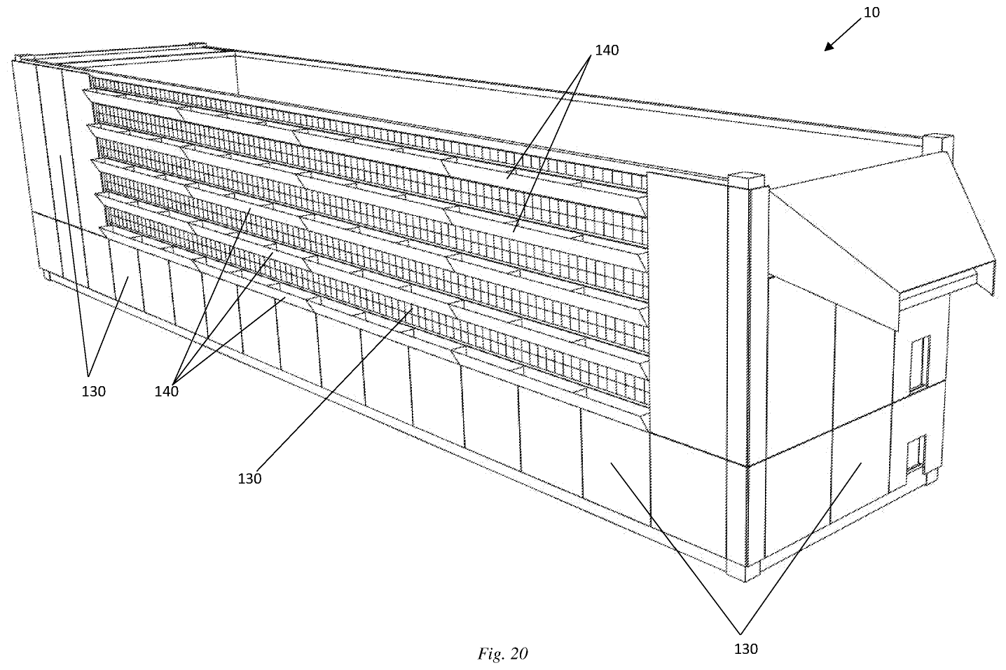

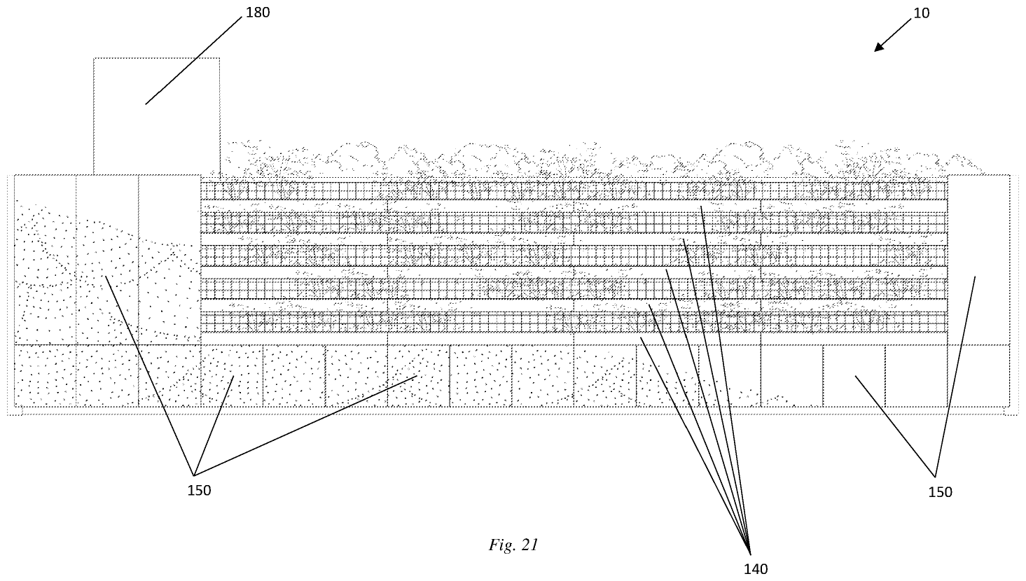

Referring to FIGS. 2, 14-16, 20 and 21, an embodiment, the container may comprise a header tank 180.

The header tank 180 may be connected to the fluid inlet 20, to store contaminated water and provide operational pressure.

The header tank 180 may alternatively be used to store at least partially treated water, for example to be directed to a third-party application such as a green wall 140 or where there may be an external requirement.

The header tank 180 may be configured to work in conjunction with a secondary internal tank 184, and/or a dosing tank 182, to provide capacity and storage for improved control of the treatment system in the container 10.

The header tank 180 may be configured to direct at least a portion of contaminated water to the green roof 142.

The header tank 180 may be raisable using a header tank lift 190, so that the header tank 180 can be raised to provide operational water pressure.

The header tank lift 190 may be a scissor lift.

The header tank lift 190 may be manually operable.

Alternatively, the header tank 180 is fixed and provides operational water pressure using a pump 186.

The capability to raise and lower the header tank 180 enables the header tank 180 to remain within the container 10 which is advantageous, for example during transportation, but then to be raised, to provide operational water pressure when the container 10 is in an operable configuration.

In use, the header tank 180 may be raised by use of the header tank lift 190.

The header tank lift 190 may be manually operable, for example by a foot operated lever, so that an external power connection is not required.

Alternatively, the header tank lift 190 may be automated or electrically driven.

Once at the desired height, the header tank 180 may be locked in position.

The header tank 180 may be locked in position with pins.

The raising of the header tank 180 may then require connection of pipework, which may be installed connecting the header tank 180 to the container 10.

Alternatively, the header tank 180 may be connected using a flexible hose.

The source of contaminated water may be connected to the fluid inlet 20.

The source of contaminated water may be the original source or may alternatively be from the fluid outlet 25 of another container 10, for example where multiple containers 10 are used in an array.

### Green Wall/Display Face

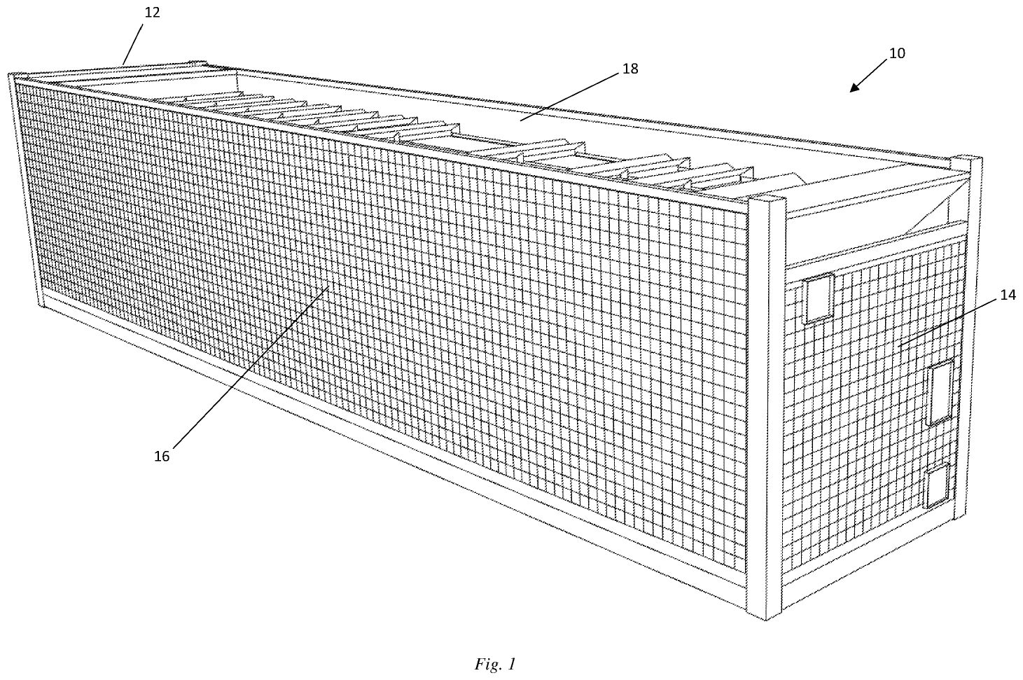

Referring to FIGS. 1, 20 and 21, in an embodiment, the container 10 comprises a plurality of panels 130 mounted to at least one external wall, wherein the or each panel 130 comprises either, or both, a green wall 140 or a display face 150.

Where at least one panel 130 supports a green wall 140, the fluid outlet 25 may be configured to direct at least a portion of treated water to the green wall 140.

The green wall 140 may be configured to receive a growth medium.

The container 10 open top may comprise a green roof 142.

The green roof 142 may be comprised of an upper layer of a plurality of interconnected tanks 100, wherein the interconnected tanks 100 are arranged in layers supported within the container 10.

At least one side of the container 10 may comprise an openable wall 110 to enable access to the interior of the container 10.

At least one of the panels 130 may be configured to cover at least a portion of the open top of the container 10 during transportation.

A plurality of panels 130 may be configured to cover the entire open top during transportation.

The open top may be between 2430 mm and 1800 mm wide.

The open top may be between 2250 mm and 1850 mm wide.

The opening or open top may be covered with a removeable mesh (not shown).

The mesh may comprise apertures no greater than 100 mm across.

At least one panel 130 may be between 400 mm and 2450 mm wide, and 2650 mm and 1900 mm high.

At least one panel 130 may be between 500 mm and 1000 mm wide, and 2430 mm and 1650 mm high.

At least one panel 130 may be between 700 mm and 750 mm wide, and 2400 mm and 1950 mm high.

At least one panel 130 may be square, between 700 mm and 750 mm wide, and 700 mm and 750 mm high.

In one embodiment, at least one of the panels 130 may be configured to be stored within the container 10 during transportation.

In use, a container 10 comprising a green wall 140 may be installed by locating the container 10 in a desired location and attaching the panels 130 to an external wall of the container 10.

The panels 130 may have been covering the top during transportation or may have been contained inside the container.

The use of the panels 130 in this way reduces waste and improves the aesthetics of the container 10, by attaching the panels 130 to the external walls, which may be dirty and exhibit damage from transportation for example.

As the top of the container 10 is required to be open during operation, but covered during transportation to protect the internal elements, any covering used during transport would otherwise need to be disposed of.

A source of contaminated water may be connected to the fluid inlet 20.

A green wall 140 may be affixed to the panel 130.

The green wall 140 may be comprised of a number of connected components.

Directing at least a portion of treated water from the fluid outlet 25 to the green wall 140.

The portion of treated water then feeds the green wall 140, allowing for a lush abundant feature upon an external wall of the container 10, with a reduced requirement for maintenance and care than would otherwise be the case.

The green wall 140 accepting at least a portion of the treated water enables the container 10 to use a portion of the output of treated water, while simultaneously improving the aesthetics.

The green wall 140 or green roof 142 may comprise planting which treats water by phytoremediation.

In such cases, it may be that a portion of contaminated water is directed to the green wall 140 or green roof 142.

At least one of the panels 130 may comprise a display face 150 configured to be located downwards during transportation, but to face outwardly when affixed to the side of the container 10.

The display face 150 may comprise artwork (not shown).

The display face 150 may comprise an interactive screen (not shown).

The display face 150 may comprises printed information (not shown).

Printed information may be related to conservation of water, for example indigenous stories about the location and the historical importance of the water source, or public information about methods to conserve and treat water.

The display faces 150 of multiple panels 130 may be configured to be interconnected.

Interconnected panels 130 may form a larger composite or collage image across their respective display faces 150.

The display faces 150 of the container 10 may be configured to be wirelessly connected to display faces 150 of other containers 10.

In embodiments in which at least one display face 150 or panel 130 comprises an interactive screen, the interactive screen may be configured to enable users to view content particular to the container 10, and content particular to other connected containers 10.

The interactive screen may comprise payment means (not shown) to procure items displayed by one or more display faces 150.

In use, in embodiments where multiple containers 10 are arranged in an array, the containers 10 may be arranged with display faces 150 situated alongside one another.

The variety of settings in which the containers 10 may be deployed requires that a variety of display faces 150 are provided suit the different landscapes or locations.

In rural or industrial setting for example, the array may not be readily visible to large number of visitors, and the green wall 140 allows the container 10 to complement surrounding landscape, or to improve the appearance by covering at least one wall of each container 10 with planting.

In urban settings, the green wall 140 can be complimented by additional display faces 150 designed to appeal to, or inform, the public.

One example of such a display face 150 is as an art installation, where artworks can be displayed behind a protective screen, and adjacent information on the artist can be provided.

Art installations may alternatively be provided via the interactive screen.

Where multiple containers are located adjacent one another in an array, the interactive screens can be interconnected, to display a larger image or video, across the plurality of faces 150.

Another example of a display faces 150 is to provide a story to the public, for example relating to an indigenous story of water with respect to the local area.

Remote connection may allow viewing members of the public to access content of other containers or installations thereof.

Remote connection may allow functionality, performance and statistics of the containers to be assessed remotely.

Modifications and variations as would be apparent to a skilled addressee are deemed to be within the scope of the present invention.

1.-63. (canceled)

64. A transportable container for treating contaminated water using biomass, the container comprising an open top, a fluid inlet and a fluid outlet and a carriage configured to move along a length of the container, wherein the carriage comprises a harvester system configured to harvest at least a portion of the biomass and wherein contaminated water is received by the fluid inlet, and treated water is directed to the fluid outlet.

65. A container according to claim 64, wherein the carriage comprises a lifting mechanism configured to raise and lower items between an interior and an exterior of the container.

66. A container according to claim 65, wherein the lifting mechanism comprises a lifting frame having a proximal end and a distal end, wherein the distal end of the lifting frame is configured to pivot over the proximal end to enable the lifting point to be suspended adjacent to the carriage.

67. A container according to claim 64, wherein the harvester system comprises a skimmer affixed to the carriage, wherein the skimmer is affixed to the carriage with an articulated arm that enables the vertical position of the skimmer to be moveable between a lowermost position and an uppermost position.

68. A container according to claim 67, wherein the articulated arm is configured to retain the orientation of the skimmer while the vertical position is moveable between a lowermost position and an uppermost position, so that optimal orientation is ensured at different vertical positions.

69. A container according to claim 67, wherein the harvester system comprises an extractor affixed to the carriage, wherein the extractor is affixed to the carriage with the articulated arm.

70. A container according to claim 64, wherein the container comprises a collector ramp proximal a second end wall.

71. A container according to claim 64, wherein the container comprises a stowable chute.

72. A container according to claim 64, wherein the container comprises a header tank.

73. A container according to claim 72, wherein the header tank is raisable using a header tank lifting device, so that the header tank can be raised to provide operational water pressure.

74. A container according to claim 64, wherein the container comprises a plurality of panels mounted to at least one external wall, wherein at least one of the panels comprises either, or both, a green wall or a display face.

75. A container according to claim 74, wherein at least one of the panels is configured to cover at least a portion of the open top of the container during transportation.

76. An array of containers, wherein at least one container of the array is a container according to claim 64, wherein the outlet of each container, with the exception of a final container in the array, is configured to direct water to the inlet of another container in the array.

77. A container configured to treat contaminated water, the container comprising an open top, a fluid inlet and a fluid outlet, wherein contaminated water is received by the fluid inlet, and treated water is directed to the fluid outlet.

78. A container according to claim 77, wherein at least one side of the container comprises an openable wall to enable access to the interior of the container, and wherein the container comprises a plurality of chambers configured to provide separable portions for at least partial retention of media.

79. A container according to claim 77, wherein the plurality of chambers comprises interconnected tanks.

80. An array of containers, wherein at least one container of the array is a container according to claim 77, wherein the outlet of each container, with the exception of a final container in the array, is configured to direct water to the inlet of another container in the array.

81. A container according to claim 77, wherein the container comprises a wireless connection device.

82. A container according to claim 77, wherein the container is configured to direct at least a portion of the contaminated or treated water to a green wall or a green roof.

83. A method of replacing plant based absorbent filtration media in a container, wherein the container comprises an open top, and inlet for receiving untreated water and an outlet for egress of treated water, wherein the container is configured to contain; a body of water having a downward direction of flow and a plurality of layers of filtration media; wherein an uppermost layer of filtration media is contained in a plurality of removable cages, wherein each cage is cuboid in shape having six rectangular faces and further comprises a lifting point, wherein the faces comprise; a pair of opposed upper and lower plates, a pair of opposed side walls and a pair of opposed end walls, wherein the upper and lower plates are permeable, wherein the cage further comprises a pivot mechanism affixed to each of the side walls, wherein the lower plate is fixed to both the side walls and the end walls, wherein the upper plate comprises a locking mechanism and is hingably connected to either a side wall or an end wall and is moveable between a closed configuration and an open configuration, the method comprising all of the following steps:
a) attaching a lifting mechanism to the lifting point of a cage,
b) raising the cage above the top of the container,
c) moving the cage laterally until the cage is suspended adjacent to the container,
d) rotating the cage so that the upper plate is facing substantially downwards,
e) releasing the locking mechanism, enabling the upper plate to fall into the open configuration and the media to fall from the cage,
f) rotating the cage so that the lower plate is facing substantially downwards,
g) lowering the cage to rest on the lower plate,
h) at least partially filling the cage with plant-based filtration media,
i) moving the upper plate into the closed configuration,
j) securing the upper plate with the locking mechanism,
k) raising the cage above the top of the container,
l) moving the cage laterally until it is suspended over its original location,
m) lowering the cage back to its original location,
n) repeating the preceding steps for any further cages requiring replacement of filtration media.
